(19) United States
(12) Patent Application Publication
(10) Pub. No.: US 2026/0255392 A1
(43) Pub. Date: Aug. 27, 2026

(54) METHODS, SYSTEMS, AND APPARATUSES FOR RETRY TIMEOUT ADJUSTMENT DURING ENHANCED DISTRIBUTED CHANNEL ACCESS CONTENTION PERIODS

(71) Applicant: Nokia Technologies Oy, Espoo (FI)

(72) Inventors: Behnam DEZFOULI, San Jose, CA (US); Klaus Franz DOPPLER, Albany, CA (US); Claude ROBERTSON, V, New York, NY (US); Salvatore TALARICO, Los Gatos, CA (US); Kerstin JOHNSSON, Palo Alto, CA (US); Mikhail LIUBOGOSHCHEV, Munich (DE)

(21) Appl. No.: 19/065,720

(22) Filed: Feb. 27, 2025

(51) Int. Cl. H04W 74/0816; H04B 17/318; H04W 74/08

(52) U.S. Cl. CPC H04W 74/0816; H04B 17/328; H04W 74/0875

(57) ABSTRACT

During an enhanced distributed channel access (EDCA) contention procedure, latency is reduced by enabling a high-priority timeout (HPTO) retry duration. A source station, following transmission in a channel to a destination station to compete for channel access, must wait some duration before determining the EDCA contention procedure failed. When the source station and/or transmission is HPTO-eligible, the source station can complete again for channel access after waiting only a short inter-frame space (SIFS) duration plus at least one additional slot duration. During the HPTO duration, the source station senses whether the channel is idle or busy, e.g., via clear channel assessment or upon receiving at least a portion of a frame. If the channel is idle during the HPTO duration, the source station determines the channel is idle and the EDCA contention procedure failed and competes again for channel access during a very next slot following the HPTO duration.

### FIELD

Various aspects of the present disclosure relate generally to techniques for latency reduction in communications, and more specifically, to retry timeout adjustment during enhanced distributed channel access contention periods.

### BACKGROUND

Wireless communication networks, such as wireless fidelity (Wi-Fi) networks, may support latency-sensitive applications at Wi-Fi stations (STAs). Some such applications include virtual reality (VR) applications, mixed reality (MR) applications, and augmented reality (XR) applications. In some cases, reliability and non-deterministic channel access, such as for wideband transmissions, may constrain a performance of latency-sensitive applications.

### BRIEF SUMMARY

Methods, apparatuses, and systems are disclosed for reducing latency during latency-sensitive applications and ultra-low latency communications. One example of such applications and communications scenarios is during enhanced distributed channel access (EDCA), such as during an EDCA contention resolution procedure. This is accomplished by, in certain circumstances, reducing the amount of time a source station must wait, following transmission in a channel of a plurality of frames addressed to a destination station, before the source station can retry the EDCA contention resolution procedure to compete for channel access. The waiting period can be reduced by implementing, in accordance with certain constraints, a high-priority timeout (HPTO) procedure.

For example, the source station can transmit a plurality of frames as part of a first EDCA contention resolution procedure. Starting during the immediately subsequent slot duration, the source station, if eligible or configured for the HPTO procedure, can wait for a short inter-frame space (SIFS) duration and one additional slot duration (or, in certain instances, more than one additional slot duration). The sum of the SIFS duration and the one or more additional slot durations is referred to as the HPTO duration. During the HPTO duration, the source station senses whether the channel is idle or busy. This can be accomplished by the source station listening for one or more frames, or one or more portions or fragments of a frame (e.g., a prefix, a header, etc.). If the channel is idle during the HPTO duration, then the source station determines it is eligible to use the HPTO duration, which means that the source station can interpret channel idleness during all slot durations of the HPTO duration as indicating that the first EDCA contention resolution procedure failed. In such a case, during the very next slot duration, the source station can initiate a second EDCA contention resolution procedure by retransmitting the plurality of frames in the channel rather than waiting for a longer, conventional EDCA contention resolution retry timeout duration.

According to some aspects, there is provided the subject matter of the independent claims. Some further aspects are defined in the dependent claims. The embodiments that do not fall under the scope of the claims are to be interpreted as examples useful for understanding the disclosure.

According to some aspects of the present disclosure, there is provided a method including transmitting a plurality of frames on a channel to initiate a first enhanced distributed channel access (EDCA) contention procedure; upon transmitting a last frame of the plurality of frames, waiting for a high-priority timeout (HPTO) duration before determining whether the first EDCA contention procedure has failed, wherein the HPTO duration is a sum of a short inter-frame space (SIFS) duration and at least one slot duration; during the at least one slot duration, determining whether the channel is idle or busy; and, in an instance in which the channel is idle during the at least one slot duration, competing to retransmit the plurality of frames on the channel in a second EDCA contention procedure.

In some embodiments, the method can further include, in an instance in which the channel is busy during any one of the at least one slot duration, determining that the apparatus is not to compete to retransmit the plurality of frames on the channel by initiating the second EDCA contention procedure after the HPTO duration and instead waiting for the channel to become idle before competing again for channel access. In some embodiments, the channel comprises one of: a physical layer channel, a control channel, a medium access control channel, a shared channel, or a data channel. In some embodiments, the at least one slot duration is at least one aSlotTime duration. In some embodiments, the at least one aSlotTime duration includes only a single aSlotTime duration. In some embodiments, the at least one aSlotTime duration includes two or more aSlotTime durations. In some embodiments, the transmitting the plurality of frames on the channel comprises transmitting the plurality of frames on the channel towards a destination station. In some embodiments, the at least one slot duration are subsequent to the SIFS duration.

In some embodiments, the method can further include: determining, based on the channel being idle during the at least one slot duration, that the apparatus is eligible to compete to retransmit the plurality of frames on the channel in the second EDCA contention procedure. In some embodiments, the method can further include: in an instance in which the channel is idle during the at least one time slot duration, determining that the first EDCA contention procedure has failed. In some embodiments, the plurality of frames are associated with an access category (AC) selected from among: background (BK), best effort (BE), video (VI), or voice (VO). In some embodiments, the method can further include: determining, based upon the AC associated with the plurality of frames, the HPTO duration that the apparatus needs to wait before competing for channel access again to retransmit the plurality of frames. In some embodiments, the plurality of frames comprise at least one of: a response-soliciting frame, a data frame, a control frame, a clear-to-send (CTS) frame, or a request-to-send (RTS) frame. In some embodiments, the method can further include: receiving, from the recipient of the response-soliciting frame, at least one response frame in response to the retransmitting of the plurality of frames; and determining, based upon the at least one response frame received from the recipient of the response-soliciting frame, a transmission opportunity (TXOP) following receipt of the response frame.

According to some aspects of the present disclosure, there is provided an apparatus that comprises means, such as means for performing some or all aspects or portions of some or all of the methods described in paragraphs [0003]-[0008].

According to some aspects of the present disclosure, there is provided an apparatus that includes at least one processor and at least one memory. Program codes can be stored in the at least one memory of the apparatus. When the program codes stored in the memory are executed by the at least one processor, it can cause the apparatus to perform some or all aspects or portions of some or all of the methods described in paragraphs [0003]-[0008].

According to some aspects of the present disclosure, there is provided a computer program product that includes, e.g., at least one non-transitory computer-readable storage medium. The non-transitory computer-readable storage medium can include program codes and/or processor-readable instructions therein that, when executed by at least one processor of an apparatus, cause the apparatus to perform some or all aspects or portions of some or all of the methods described in paragraphs [0003]-[0008].

According to some aspects of the present disclosure, there is provided a method that includes: transmitting a plurality of frames on a channel in a first enhanced distributed channel access (EDCA) contention procedure; after waiting for a response frame reception timeout duration, followed by an arbitration inter-frame space (AIFS) duration, if at least one response frame has not been received during the response frame reception timeout duration, determining that the first EDCA contention procedure has failed; upon determining that the first EDCA contention procedure has failed, compete for channel access and retransmit the plurality of frames on the channel in a second EDCA contention procedure; after retransmitting the plurality of frames, waiting for a high-priority timeout (HPTO) duration, wherein the HPTO duration is a sum of a short inter-frame space (SIFS) duration and at least one slot duration subsequent to the SIFS duration; determining whether the channel is idle or busy during the at least one slot duration of the HPTO duration; and, in an instance in which the channel is idle during the at least one slot duration of the HPTO duration, compete for channel access to retransmit the plurality of frames in the channel in a third EDCA contention procedure.

In some embodiments, the method can further include: in an instance in which the channel is busy during at least one slot duration of the HPTO duration, waiting for the channel to be idle or to receive at least a part of a frame, and then following EDCA rules for competing for channel access again for channel access to retransmit the plurality of frames in the channel.

In some embodiments, the method can further include: in an instance in which the channel is busy during any slot of the HPTO duration, waiting for the channel to become idle or receive at least a part of a frame; and upon determining the channel is idle or upon receiving at least a part of a frame, following EDCA rules for competing again for channel access to retransmit the plurality of frames in the channel.

In some embodiments, the plurality of frames are associated with an access category (AC) selected from among: background (BK), best effort (BE), video (VI), or voice (VO). In some embodiments, the method can further include: determining, based upon the AC associated with the plurality of frames, that the apparatus is eligible to compete for channel access to retransmit the plurality of frames on the channel immediately following the HPTO

In some embodiments, the plurality of frames comprise at least one of: a data frame, a response-soliciting frame, a short control frame, a clear-to-send (CTS) frame, or a request-to-send (RTS) frame. In some embodiments, the method can further include: receiving at least one response frame in response to the retransmission of the plurality of frames in the channel; and determining, based upon the at least one response frames received, a transmission opportunity (TXOP) following receipt of the at least one response frame.

According to some aspects of the present disclosure, there is provided an apparatus that comprises means, such as means for performing some or all aspects or portions of some or all of the methods described in paragraphs [0012]-[0016].

According to some aspects of the present disclosure, there is provided an apparatus that includes at least one processor and at least one memory. Program codes can be stored in the at least one memory of the apparatus. When the program codes stored in the memory are executed by the at least one processor, it can cause the apparatus to perform some or all aspects or portions of some or all of the methods described in paragraphs [0012]-[0016].

According to some aspects of the present disclosure, there is provided a computer program product that includes, e.g., at least one non-transitory computer-readable storage medium. The non-transitory computer-readable storage medium can include program codes and/or processor-readable instructions therein that, when executed by at least one processor of an apparatus, cause the apparatus to perform some or all aspects or portions of some or all of the methods described in paragraphs [0012]-[0016].

According to some aspects of the present disclosure, there is provided a method that includes: transmitting a plurality of frames, addressed to a destination station, on a channel, in a first enhanced distributed channel access (EDCA) contention procedure; following the transmitting of a last frame of the plurality of frames on the channel towards the destination station, waiting for a high-priority timeout (HPTO) duration before determining, based upon the idle or busy state of the channel, an outcome of the first EDCA contention procedure, wherein the HPTO duration is a sum of a short inter-frame space (SIFS) duration and at least one slot duration; during the at least one slot duration, determining whether the channel is idle or busy; and, in an instance in which the channel is idle during the at least one slot of the HPTO duration, determining that the apparatus is eligible for waiting for the HPTO duration before initiating a second EDCA contention procedure to retransmit the plurality of frames addressed to the destination station on the channel.

In some embodiments, the method can further include: determining, based on the channel being idle during each slot duration of the HPTO duration, that the apparatus is eligible to initiate the third EDCA contention procedure following the HPTO duration to retransmit the plurality of frames addressed to the destination station in the channel. In some embodiments, the plurality of frames are associated with one or more access categories (ACs) selected from among: background (BK), best effort (BE), video (VI), or voice (VO). In some embodiments, the method can further include: determining, based upon the AC associated with the plurality of frames, that the apparatus is eligible to compete for channel access to retransmit the plurality of frames on the channel immediately following the HPTO duration as part of the third EDCA contention procedure.

In some embodiments, the plurality of frames comprise at least one of: a data frame, a response-soliciting frame, a short control frame, a clear-to-send (CTS) frame, or a request-to-send (RTS) frame. In some embodiments, the method can further include: receiving, in response to retransmitting the plurality of frames addressed to the destination station in the channel, at least one response frame from the destination station; and determining, based upon the at least one response frame received from the destination station, a transmission opportunity (TXOP) following receipt of the at least one response frame.

According to some aspects of the present disclosure, there is provided an apparatus that comprises means, such as means for performing some or all aspects or portions of some or all of the methods described in paragraphs [0020]-[0022].

According to some aspects of the present disclosure, there is provided an apparatus that includes at least one processor and at least one memory. Program codes can be stored in the at least one memory of the apparatus. When the program codes stored in the memory are executed by the at least one processor, it can cause the apparatus to perform some or all aspects or portions of some or all of the methods described in paragraphs [0020]-[0022].

According to some aspects of the present disclosure, there is provided a computer program product that includes, e.g., at least one non-transitory computer-readable storage medium. The non-transitory computer-readable storage medium can include program codes and/or processor-readable instructions therein that, when executed by at least one processor of an apparatus, cause the apparatus to perform some or all aspects or portions of some or all of the methods described in paragraphs [0020]-[0022].

According to some aspects of the present disclosure, there is provided a method that includes: determining, based at least upon one or more parameters associated with a plurality of frames transmitted by the apparatus in a channel as part of a first enhanced distributed channel access (EDCA) contention procedure to compete for channel access, whether the apparatus is eligible to retransmit the plurality of frames in the channel as part of a second EDCA contention procedure to compete for channel access after only waiting for a high-priority timeout (HPTO) duration following an end of the transmission of the plurality of frames and determining that the first EDCA contention procedure has failed, wherein the HPTO duration is a sum of a short inter-frame space (SIFS) duration and at least one slot duration; determining, based on whether the channel is sensed as being idle during each slot of the HPTO duration following the end of the transmission of the plurality of frames as part of the first EDCA contention procedure, that the first EDCA contention procedure failed; and, if the first EDCA contention procedure failed and the apparatus is eligible to compete for channel access to retransmit the plurality of frames on the channel immediately following the HPTO duration, starting in a first slot immediately following the end of the HPTO duration as part of the second EDCA contention procedure.

In some embodiments, the plurality of frames are addressed to a destination station. In some embodiments, the plurality of frames comprise at least one of: a response-soliciting frame, a data frame, a short control frame, a clear-to-send (CTS) frame, or a request-to-send (RTS) frame. In some embodiments, a device performs the EDCA contention procedure to compete for channel access to transmit in the channel the plurality of frames addressed to the destination station.

In some embodiments, the one or more parameters comprise information indicating at least one access category (AC) from among a plurality of ACs, the at least one AC being associated with the plurality of frames. In some embodiments, the method can further include: determining whether the at least one AC associated with the plurality of frames is one of a high-priority ACs among the plurality of ACs. In some embodiments, the method can further include: in an instance in which the channel is idle during each slot of the HPTO duration and the plurality of frames are associated with at least one of the high-priority ACs, determining that the apparatus is eligible to retransmit the transmission in the channel as part of the second EDCA contention procedure to compete again for channel access starting in the first slot following the end of the HPTO duration.

In some embodiments, the one or more parameters associated with the plurality of frames comprise a size of the plurality of frames. In some embodiments, the method can further include: in an instance in which the channel is idle during each slot of the HPTO duration and the size of the plurality of frames is less than a threshold, determining that the apparatus is eligible to compete for channel access to retransmit the plurality of frames in the channel as part of the second EDCA contention procedure starting in the first slot following the end of the HPTO duration.

In some embodiments, the one or more parameters associated with transmission of the plurality of frames comprise a number of experienced EDCA contention procedure failures associated with transmission of the plurality of frames. In some embodiments, the method can further include: in an instance in which the channel is idle during each slot of the HPTO duration and the number of experienced EDCA contention procedure failures associated with transmission of the plurality of frames is more than a threshold, determining that the apparatus is eligible to compete for channel access to retransmit the plurality of frames in the channel as part of the second EDCA contention procedure starting in the first slot following the end of the HPTO duration.

In some embodiments, the one or more parameters associated with the plurality of frames comprise a received signal strength indication (RSSI) associated with a link used to transmit the plurality of frames. In some embodiments, the method can further include: in an instance in which the channel is idle during each slot of the HPTO duration and the RSSI associated with the transmission of the plurality of frames is less than a threshold, determining that the apparatus is eligible to compete for channel access to retransmit the plurality of frames in the channel as part of the second EDCA contention procedure starting in the first slot following the end of the HPTO duration. In some embodiments, the method can further include: in an instance in which the channel is idle during each slot of the HPTO duration and the RSSI associated with the transmission of the plurality of frames is greater than or equal to the threshold, determining that the apparatus is eligible to compete for channel access to retransmit the plurality of frames in the channel as part of the second EDCA contention procedure starting in the first slot following the end of the HPTO duration.

In some embodiments, the channel comprises one of: a physical layer channel, a control channel, a medium access control channel, a shared channel, or a data channel. In some embodiments, the at least one slot duration is at least one aSlotTime duration. In some embodiments, the at least one aSlotTime duration includes only a single aSlotTime duration. In some embodiments, the at least one aSlotTime duration includes two or more aSlotTime durations. In some embodiments, the plurality of frames are addressed to a destination station. In some embodiments, the destination station is or comprises an access point (AP) station, and wherein the apparatus is or comprises a non-AP station. In some embodiments, the method can further include: determining, based at least upon receipt at the apparatus of at least one response frame, a transmission opportunity (TXOP) following the receipt at the apparatus of the at least one response frame.

According to some aspects of the present disclosure, there is provided an apparatus that comprises means, such as means for performing some or all aspects or portions of some or all of the methods described in paragraphs [0026]-[0032].

According to some aspects of the present disclosure, there is provided an apparatus that includes at least one processor and at least one memory. Program codes can be stored in the at least one memory of the apparatus. When the program codes stored in the memory are executed by the at least one processor, it can cause the apparatus to perform some or all aspects or portions of some or all of the methods described in paragraphs [0026]-[0032].

According to some aspects of the present disclosure, there is provided a computer program product that includes, e.g., at least one non-transitory computer-readable storage medium. The non-transitory computer-readable storage medium can include program codes and/or processor-readable instructions therein that, when executed by at least one processor of an apparatus, cause the apparatus to perform some or all aspects or portions of some or all of the methods described in paragraphs [0026]-[0032].

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an example communications network to which one or more examples disclosed herein may be applied;

FIG. 2 illustrates an example communications system to which one or more examples disclosed herein may be applied;

FIG. 3 illustrates an example timing diagram to which one or more examples disclosed herein may be applied;

FIG. 4 illustrates an example timing diagram to which one or more examples disclosed herein may be applied;

FIG. 5 illustrates an example timing diagram to which one or more examples disclosed herein may be applied;

FIG. 6 illustrates a process for determining HPTO eligibility for an STA, in accordance with some embodiments disclosed herein;

FIG. 7 illustrates an example timing diagram to which one or more examples disclosed herein may be applied;

FIG. 8 illustrates an example timing diagram to which one or more examples disclosed herein may be applied;

FIG. 9 illustrates an example timing diagram to which one or more examples disclosed herein may be applied;

FIG. 10 illustrates an example timing diagram to which one or more examples disclosed herein may be applied;

FIG. 11 illustrates an example signaling diagram to which one or more examples disclosed herein may be applied;

FIG. 12 illustrates an example signaling diagram to which one or more examples disclosed herein may be applied;

FIG. 13 illustrates an example flowchart of a method to which one or more examples disclosed herein may be applied;

FIG. 14 illustrates an example flowchart of a method to which one or more examples disclosed herein may be applied; and

FIG. 15 illustrates an example block diagram of an apparatus to which one or more examples disclosed herein may be applied.

### ABBREVIATIONS

AP Access Point
AC Access Category
AC_VO Voice Access Category
AC_VI Video Access Category
ACK Acknowledgement
AIFS Arbitration Inter-Frame Space
BA Block Acknowledgement
CCA Clear Channel Assessment
CW Contention Window
DS Defer Signal
EDCA Enhanced Distributed Channel Access
EIFS Extended Inter-Frame Space
EHT Extremely High Throughput
HT High Throughput
MAC Medium Access Control
MU-MIMO Multi-User Multiple-Input Multiple-Output
NAV Network Allocation Vector
OFDMA Orthogonal Frequency-Division Multiple Access
LL Low Latency
LL-STA Low Latency Station
SIFS Short Inter-Frame Space
STA Station
TF Trigger Frame
TXOP Transmission Opportunity
TS Timeslot
VO Voice
VI Video
VOIP Voice over IP (Internet Protocol)
VHT Very High Throughput
P2P Peer-to-Peer
PIFS Priority Inter-frame Space
PPDU PHY Protocol Data Unit
QoS Quality of Service
RSSI Received Signal Strength
UHR Ultra-High Reliability
UL Uplink
DL Downlink
XR Mixed Reality (includes Virtual Reality and Augmented Reality)

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of some embodiments, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

As used herein, the term “network device” or “network node” refers to a node in a communication network via which user equipment may access the network and/or which is capable of controlling radio communication and managing radio resources within a cell. The network node or network device may be referred to as a base station (BS), an access point (AP) or an access node. The network device may be, depending on the applied technology, for example, a node B (NodeB or NB), an evolved NodeB (eNodeB or eNB), an NR NB (also referred to as a gNB), a Remote Radio Unit (RRU), a radio head (RH), a remote radio head (RRH), a relay, an Integrated Access and Backhaul (IAB) node, a low power node, a non-terrestrial network (NTN) or non-ground network device such as a satellite network device, a low earth orbit (LEO) satellite and a geosynchronous earth orbit (GEO) satellite, or an aircraft network device.

Moreover, in connection of split radio access network (RAN), the network device may refer to a centralised unit (CU) of a base station and/or a distributed unit (DU) of a base station. An interface between CU and DU may be referred to as an F1 interface in NR. In the split RAN architecture, node operations may be carried out, at least partly, in the central/centralized unit (CU) (e.g., server, host or node) operationally coupled to the DU, (e.g., a radio head/node). One CU may control one or more DUs, acting at least as transmit/receive (Tx/Rx) nodes. In some embodiments, the DUs may include e.g., a radio link control (RLC), medium access control (MAC) layer and a physical (PHY) layer, whereas the CU may include the layers above RLC layer, such as a packet data convergence protocol (PDCP) layer, a radio resource control (RRC) and an internet protocol (IP) layers. Other functional splits are possible too. In practice, any processing task may be performed in either the CU or the DU and the boundary where the responsibility is shifted between the CU and the DU may depend on the applied implementation.

The term “terminal device” refers to any end device that may be capable of wireless communication. By way of example, a terminal device may be referred to as a communication device, user equipment (UE), a Subscriber Station (SS), or a Mobile Station (MS). The terminal device may include a mobile phone, a cellular phone, a smart phone, voice over IP (VOIP) phones, wireless local loop phones a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, USB dongles, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

A term “resource”, as used herein, may refer to radio resources in time domain, in frequency domain, in space domain, and/or in code domain. Some examples of resources include e.g., a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources.

The term “including” means including but not limited to and should be interpreted in the manner it is typically used in the patent context. Use of broader terms such as includes, includes, and having should be understood to provide support for narrower terms such as consisting of, consisting essentially of, and included substantially of. Furthermore, to the extent that the terms “includes” and “including,” and variants thereof are used in either the detailed description or the claims, these terms are intended to be inclusive in a manner similar to the term “including.”

The phrases “in some embodiments,” “according to some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to signal, non-transitory computer-readable medium and the like. The term ‘non-transitory computer-readable medium’ refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

Certain embodiments described may be implemented in a communication network, such as any of the following radio access technologies (RATs): Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future RAT such as 6G. Moreover, communication within the communication network may utilize any proper wireless communication technology, including but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), and/or Discrete Fourier Transform spread OFDM (DFT-s-OFDM).

In some examples, a communications system may be deployed in a wireless local area network (WLAN), such as a Wi-Fi network. That is, in some examples, a communications system may be an example of a WLAN system. The WLAN system may support wireless communications between one or more communications devices in accordance with one or more Wi-Fi protocols, such as protocols based on institute of electrical and electronics engineers (IEEE) 802.11 standards and/or related drafts, such as 802.11-2020, 802.11ac, 802.11ax, 802.11be, 802.11bn, and/or others, the entireties of the disclosures of each of which are hereby incorporated herein by reference in their entireties for all purposes.

In some examples, Wi-Fi communications may occur via one or more radio frequency bands, such as 2.4 gigahertz (GHz), 3.6 GHz, 5 GHZ, 6 GHz, 60 GHz, and/or the like. In some such examples, each radio frequency band may support one or more channels (e.g., 20 megahertz (MHz) channels) over which data may be communicated. In some examples, multiple devices may use multiple channels to communicate over the WLAN simultaneously.

A WLAN system may include one or more communications devices, such as an access points (APs) and/or a station (STA), which is also referred to herein as a non-AP STA. The terms ‘STA,’ and ‘station,’ are likewise used interchangeably here to refer to an AP, a STA, a destination STA, a source STA, and other equipment sending, receiving, or otherwise intercepting or sensing frames, beacons, messages, control information, data, or other such signaling within a communication system. For example, a device configured to support one or more Wi-Fi protocols may be an example of an AP (e.g., may operate in accordance with an AP mode) and/or may be an example of a non-AP STA (e.g., may operate in accordance with a non-AP STA mode). In some examples, an AP may control Wi-Fi communications for one or more non-AP STAs. For example, an AP may be (or may be connected to) a central entity used to establish (and/or control) one or more connections between one or more non-AP STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID) or a basic service set identifier (BSSID).

In some examples, an AP of a WLAN system includes at least one distribution system access function configured to facilitate data communication beyond the AP. Additionally, or alternatively, non-AP STAs may be configured to be end devices, which rely on association with an AP to communicate with devices other than the AP. An AP may be configured to connect to a wired local area network (LAN) (e.g., via Ethernet). The AP may allow one or more client devices (e.g., non-AP STAs) to access wireless connections via WLAN. The client devices may also be referred to as “WLAN clients”. WLAN clients may comprise various devices and/or types of devices, including laptops, tablets, cell phones, and/or other devices.

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity, which may be configured to act as a network manager.

In some examples, the network manager is a cloud-based entity, which may reside either in a private cloud or in a public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN.

In other examples, a centralized network manager may use a wireless system to provide local connection to clients (e.g., STAs). For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network.

Additionally, or alternatively, the WLAN system may support an ad hoc topology, which does not rely on infrastructure (e.g., cables, routers, servers, or APs). In some examples of an ad hoc network, one or more STAs (e.g., non-AP STAs, also referred to as clients or client devices) may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more STAs (e.g., one or more APs and/or one or more non-AP STAs), may communicate wirelessly with one or more other APs.

In accordance with one or more Wi-Fi protocols, data may be transmitted wirelessly between two devices (e.g., an AP and a non-AP STA) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs.

In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDU, wherein a payload of a PDU may comprise user data, control data, management data, and/or other data. In some examples, a WLAN system may implement one or more security protocols to protect the confidentiality, integrity, and availability of Wi-Fi communications.

In some examples, a WLAN system may support transmission opportunities (TXOPs) to increase throughput, such as for high priority data, by providing contention-free channel access for a period of time. A TXOP may be available in a quality of service (QoS) mode as part of Enhanced Distributed Channel Access (EDCA), and/or may be a limited time period of contention-free channel access available to the channel-owning station (e.g., the TXOP holder). During such a period a TXOP holder, which may be a non-AP STA or an AP, may send multiple frames that satisfy criteria, which may have been determined for the use of TXOP. In some examples, the criteria may allow transmission of frames belonging to an access category (AC) other than the AC for which the TXOP has been obtained. In some examples, a TXOP may increase throughput and/or reduce delay of QoS data frames by eliminating contention periods between transmissions. In some examples, a TXOP may be used in combination with frame aggregation and block acknowledgement to further increase throughput.

In some examples, access categories have different channel access parameters, such as Arbitration Inter-frame Spacing (AIFS), duration, contention window size, and TXOP limit. In some examples, values of these parameters may be set in a manner that increases a likelihood of higher priority packets being prioritized over lower priority packets. For example, the values of the parameters may be set that a non-AP STA (typically) waits for a shorter duration before sending the higher priority packets compared to a duration that the non-AP STA may wait before sending the lower priority packets. Additionally, or alternatively, the values of the parameters may be set so that the contention window for higher priority packets is smaller than that of lower priority packets and/or so that multiple packets may be sent in a TXOP. In some examples, a TXOP holder, which may be either a non-AP STA or an AP, may send frames to multiple recipients during a TXOP. In addition to QoS data frames, other frames may be exchanged during the TXOP, such as an acknowledgement (ACK), BlockAckReq/BlockAck frames, and/or other control and management frames.

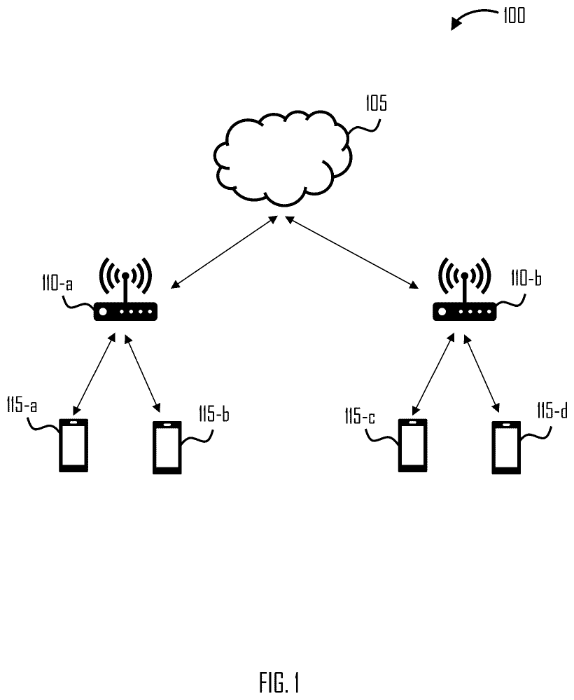

FIG. 1 illustrates an example communications system 100 to which one or more examples disclosed herein may be applied. The communications system 100 may include a cloud network 105, one or more APs (e.g., an AP 110-a, an AP 110-b), and one or more client devices, also referred to herein as non-AP STAs, connected to the one or more APs. For example, the communications system 100 may include a non-AP STA 115-a and a non-AP STA 115-b connected to the AP 110-a, as well as a non-AP STA 115-c and a non-AP STA 115-d connected to the AP 110-b. In some examples, the APs 110 may be mobile access points (mAPs) with constrained functionality. In some such examples, a configuration comprising an mAP and a non-AP STA may be implemented as part of a peer-to-peer connection, for example, as in Wi-Fi Direct or Wi-Fi Aware. In some examples, a device may simultaneously operate as a non-AP STA and as an AP. One such an example case is in a multi-AP network, which includes two or more devices that may act as APs and use Wi-Fi for the wireless backhaul connectivity based on a non-AP STA-AP connection model.

In some wireless communications systems, APs may provide wireless connectivity for one or more non-AP STAs according to the Wi-Fi standards, such as those that are a subset of the IEEE 802 family of standards. For example, the MAC and PHY specifications for Wi-Fi access points are defined by IEEE 802.11 for transmitting and receiving data in frequency bands such as 2.4 GHz, 3.6 GHz, 5 GHZ, 6 GHz, 60 GHz, and/or the like. APs and non-AP STAs may communicate through the transmission of frames, including data frames, management frames, and/or control frames, which may be transmitted in unicast messages, broadcast messages, or multicast messages. The 802.11 standards define an inter-frame space (IFS) as the nominal time (in microseconds (μs)) that the MAC and PHY use to receive the last symbol of a frame, process the frame, and respond with the first symbol of a response frame (e.g., the earliest possible response frame).

In the example of FIG. 1, the non-AP STAs 115 may be configured to be in a wireless connection with at least one Wi-Fi AP (e.g., the APs 110). According to some embodiments, functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, non-AP STAs, UEs, and/or other entities suitable for such usage. For example, the communications system 100 may support radio frequency sensing during IFS.

The communications system 100 may support latency-sensitive applications at Wi-Fi devices (e.g., APs, non-AP STAs). Some such applications may include for example virtual reality applications, mixed reality applications, and augmented reality (XR) applications. In some cases, reliability and non-deterministic channel access, such as for wideband transmissions, may constrain a performance of latency-sensitive applications. For example, for a wideband transmission (or channel bonding), a devices may use a primary 20 MHz channel to communicate control frames and management frames and may communicate data frames by bonding a BSS primary channel with one or more other available 20 MHz channels, which are referred to as secondary channels. Channel bonding was introduced to provide for transmissions over multiple contiguous 20 MHz channels. In some instances, channel bonding may support transmissions over a total bandwidth of 40 MHz, 80 MHz, 160 MHz, or 320 MHz.

The IEEE 802.11 standard provides for QoE enhancements to wireless networks, such as a WLAN supporting Wi-Fi. Among the QoE enhancements supported, EDCA supports differentiated, distributed access to Wi-Fi by using different user priority sub-fields and access categories to prioritize frames related to voice and video content, and other frames associated with latency-sensitive applications. EDCA is a contention-based channel access method for medium access control (MAC). EDCA improves on distributed coordination function (DCF) by changing the Inter-Frame Space, contention window (CW), and the contention free period based on the access category (AC) of the data or other frames being transmitted. EDCA uses Short Inter-Frame Space (SIFS) and Arbitration Inter-Frame Space (AIFS). AIFS can be calculated using an AIFS number (AISFN) as follows:

$$AIFS = SIFS + AIFSN * slot time$$

EDCA can be used with basic access mechanisms as well as RTS/CTS access mechanisms. Maximum and minimum contention window durations were established for different types of data, such as voice, video, best effort, and background.

Among the various features of EDCA, several are germane to this disclosure, such as AC, AC-differentiated AIFS, contention window for different ACs, virtual collision penalizing processes for different priority queues in the same station (STA), such as using ITS, evaluation of different VCH characteristics, etc., and Transmission Opportunity (TXOP) establishment and communications.

Under IEEE 802.11, STAs can send a response-soliciting frame or data to initiate or as part of an EDCA access contention procedure to compete for channel access and resources with other EDCA access contention requests from other STAs. STAs that send response-soliciting frames are required to wait for an ACK Timeout duration before determining transmission failure and competing for channel access again (see, IEEE Std 802.11-2020, e.g., Sections 10.3.2.9 and 10.3.2.11). When an STA transmits, for example, an RTS (Request to Send) frame, it expects and listens for a CTS (Clear to Send) response from the intended recipient. To manage this process, the STA waits for a CTSTimeout interval, which is defined as aSIFSTime+aSlotTime+aRxPHYStartDelay. This waiting period begins once the PHY-TXEND.confirm primitive is received, indicating that the RTS transmission has been completed. During the CTSTimeout interval, if the STA does not detect a PHY-RXSTART.indication primitive (a signal that an incoming frame is arriving) it assumes that the RTS transmission has failed. This failure could be due to interference, collisions, or the recipient being unable to respond. As a result, the STA invokes a backoff procedure. However, if a PHY-RXSTART.indication primitive is detected within the timeout interval, the STA waits further for the PHY-RXEND.indication primitive to analyze whether the RTS transmission was successful. If the received frame is a valid CTS frame from the intended recipient, the STA considers the RTS transmission successful and proceeds with the frame exchange sequence. Conversely, if the received frame is anything other than a valid CTS (including another valid but unexpected frame), the STA interprets this as a failure of the RTS transmission. In such cases, the STA initiates the backoff procedure while still having the option to process the received frame.

When a STA transmits a data frame that requires an Acknowledgment (Ack) or Block Acknowledgment (BlockAck) frame, it must wait for a response within a defined AckTimeout interval. Similar to the CTSTimeout interval, the AckTimeout interval is calculated as aSIFSTime+aSlotTime+aRxPHYStartDelay, and it begins upon receiving the PHY-TXEND.confirm primitive, which signifies the completion of the MPDU transmission. If the STA does not detect a PHY-RXSTART.indication primitive within this interval, it assumes that the frame transmission has failed. Consequently, the STA initiates the backoff procedure to retry the transmission. On the other hand, if a PHY-RXSTART.indication primitive is detected within the timeout interval, the STA waits for the PHY-RXEND.indication primitive to confirm whether the received frame is an acknowledgment of the transmitted frame. If the STA successfully identifies a valid Ack frame addressed to it, the transmission is considered successful, and no further retransmission is needed. However, if no valid Ack frame is received, or if the received frame does not match the expected acknowledgment, the STA assumes that the frame transmission has failed. In such cases, the STA invokes the backoff procedure again.

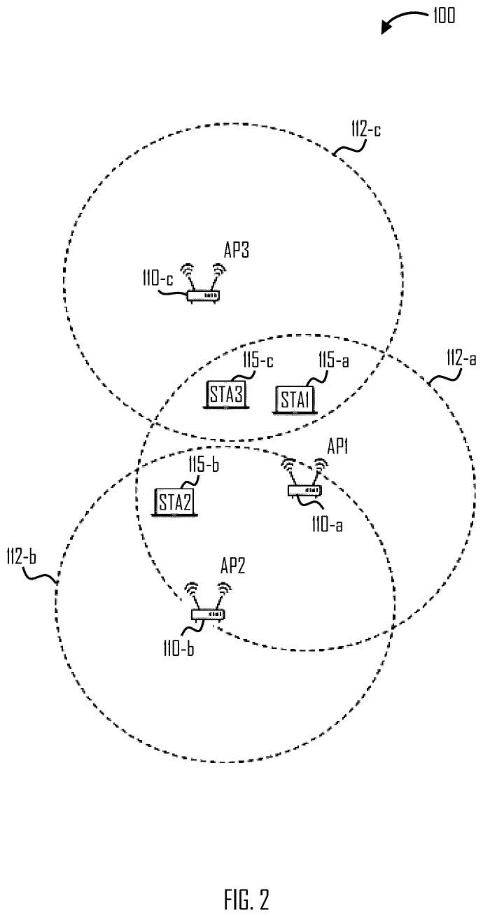

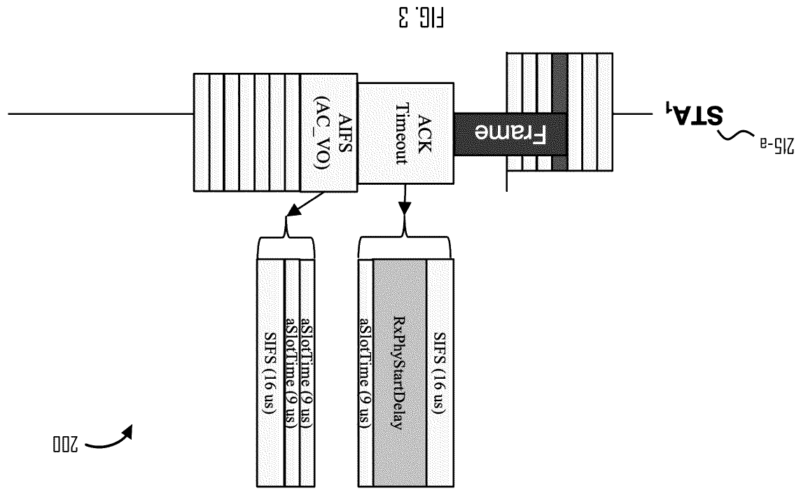

FIG. 3 illustrates an example timing diagram 200 to which one or more examples disclosed herein may be applied. In timing diagram 200, an example of a EDCA contention procedure timeline is illustrated for STA 215, which can be similar to the STAs (e.g., 115-a) illustrated in FIGS. 1 and 2.

As shown, the STA 215, at a specific time slot, transmits a frame on a channel. The frame can be addressed to a destination STA. The destination STA can be an access point (AP) STA. Transmission by the STA 215 of the frame on the channel will take a non-zero number of slot durations. Immediately following completion of transmission by the STA 215 of the frame on the channel, the STA 215 will begin waiting for an Acknowledgement (ACK) Timeout duration. The ACK Timeout duration is calculated based on aSIFSTime+RxPhyStartDelay+aSlotTime. If no indication of packet reception is received by the end of this duration, the STA 215 waits for AIFS[AC], where AC designates the access category or access categories associated with the frame, and then competes for channel access again. AIFS[AC] will include different numbers of aSlotTime durations based upon the AC type. For example, if the frame comprises voice data, the AC will be VO, and the number of aSlotTime durations used for calculating AIFS[AC] may be, e.g., two (2). Different numbers of aSlotTime durations can be used for different AC types.

Additional information about EDCA can be found in IEEE Std 802.11-2020, the entire disclosure of which is incorporated herein by reference in its entirety for all purposes.

In recent years, efforts have been made to further improve channel access latency in 802.11 networks, particularly for low-latency traffic, with a focus on enhancing the EDCA mechanism to address the needs of latency-sensitive applications. High-Priority EDCA (HiP EDCA) aimed to reduce tail latency in channel access and enhance latency predictability for low-latency (LL) traffic. HiP EDCA was introduced, in part, because the EDCA mechanism often struggles to provide adequate separation between traffic categories, particularly when multiple LL streams compete for the channel. Additional information about HiP EDCA can be found in IEEE Std. 802.11-23/1065r0, IEEE Std. 802.11-23/2126r3, IEEE Std. 802.11-24/0467r1, IEEE Std. 802.11-24/0840r0, IEEE Std. 802.11-24/1144r1, and IEEE Std. 802.11-24/1918r0, the entire disclosures of each of which are hereby incorporated herein by reference in their entireties for all purposes.

To address this problem, HiP EDCA introduced a mechanism in which STAs with LL traffic can send a Defer Signal (DS) to initiate high-priority channel access. Sending DS frames allows LL STAs to contend among themselves, avoiding competition with lower-priority traffic (e.g., STAs with best-effort traffic) or LL STAs that have not sent the DS frame. The HiP EDCA mechanism (see, e.g., IEEE 802.11-24/1144r1, and IEEE 802.11-24/1918r0) utilizes a short control frame (CTS, i.e., clear-to-send, or RTS, i.e., request-to-send) as the DS frame. A STA may send a DS frame after a certain number of failed channel access attempts (other conditions for transmitting a DS frame may be set by the AP). Once a STA sends a DS frame, it can compete for channel access after an Arbitration Inter-Frame Space (AIFS) following the end of the DS frame. STAs that successfully receive the DS frame use the Duration field (Duration/ID) value to update their Network Allocation Vector (NAV) before attempting channel access again. Also, STAs that receive only the PHY preamble or PHY header will set an Extended Inter-Frame Space (EIFS) before reattempting channel access. Thus, this method increases the likelihood that STAs transmitting a DS frame will win channel access, prioritizing LL traffic and improving latency performance.

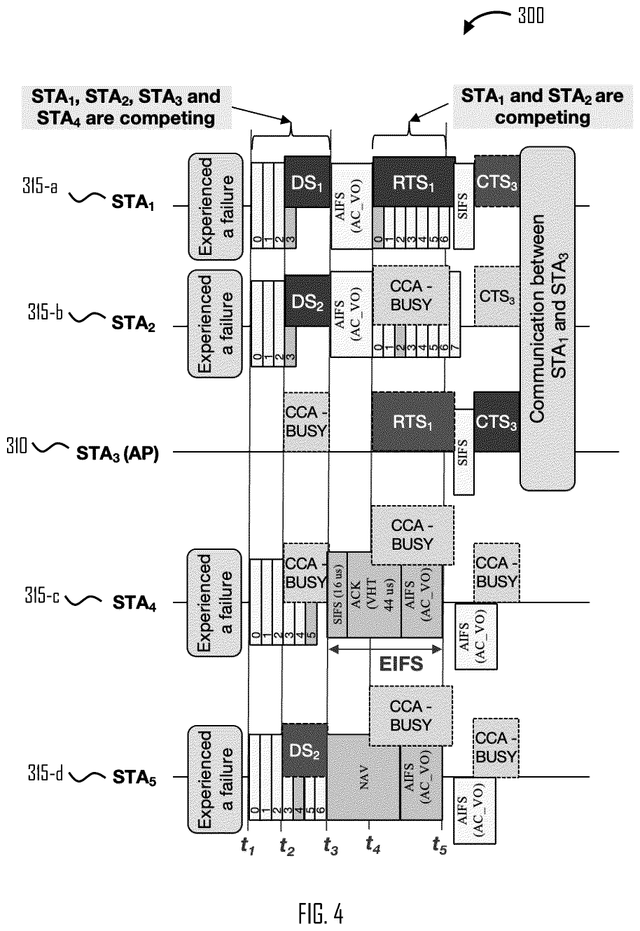

FIG. 4 illustrates an example timing diagram 300 to which one or more examples disclosed herein may be applied. In timing diagram 300, a timeline of EDCA access contention procedure operations is provided that illustrates various EDCA (e.g., High-Priority [HiP] EDCA) mechanisms. As illustrated, STA₁ 315-a, STA₂ 315-b, STA₄ 315-c, and STA₅ 315-d need to transmit LL traffic (belonging to AC_VO) to STA₃ 310 (AP). In the illustrated circumstance, STA₁ 315-a, STA₂ 315-b, STA₄ 315-c, and STA₅ 315-d have experienced a certain number of failures (e.g., an RTS transmission without any response) during the contention rounds prior to time t₁ and now send DS frames instead. Among these STAs, STA₁ 315-a and STA₂ 315-b are shown during a first Clear Channel Assessment (CCA) period as selecting earlier timeslots compared to STA₄ 315-c and STA₅ 315-d. According to some embodiments, STA₁ 315-a and STA₂ 315-b select timeslot #3, STA₄ 315-c selects timeslot #5 and STA₅ 315-d selects timeslot #4. Since STA₁ 315-a and STA₂ 315-b select the same timeslot (starting at t₂), they transmit their DS frames simultaneously.

Following transmission by STA₁ 315-a and STA₂ 315-b, starting at t₂, of their respective DS frames, STA₄ 315-c only receives a portion of the DS frame sent by STA₂ 315-b (e.g., the PHY header of the DS frame sent by STA₂ 315-b). Upon receipt of the PHY header from the DS frame transmitted by STA₂ 315-b, STA₄ 315-c waits for the EIFS duration before reattempting channel access. In contrast, STA₅ 315-d successfully receives the entire DS frame sent by STA₂ 315-b (denoted DS₂). Therefore, STA₅ 315-d uses the Duration field of this DS frame to set its NAV. The duration of NAV+AIFS is set to be the same as the duration set by the EIFS process. Consequently, both STA₄ 315-c and STA₅ 315-d can compete for channel access again at time t₅.

However, STA₁ 315-a and STA₂ 315-b can compete for channel access before STA₄ 315-c and STA₅ 315-d. According to some embodiments, the earliest timeslot that STA₁ 315-a and STA₂ 315-b can select is at t₄, which in this scenario where the AC is assumed to be VO, is AIFS[AC_VO] after the end of their DS frame transmissions.

As illustrated in FIG. 4, EIFS=aSIFSTime+AckTxTime+AIFS[AC]. In this disclosure, SIFS and aSIFSTime are interchangeably. For the calculation of EIFS, the ACK Transmission Time (AckTxTime) used by STA₂ 315-a is around 44 microseconds (for 6 Mbps HT BPSK modulation) (see e.g., IEEE 802.11-2020 standard, at Table 10-8).

As illustrated in FIG. 4, STA₁ 315-a selects timeslot #0 and sends an RTS frame starting at time t₄. Since STA₂ 315-b selects timeslot #2, it cannot initiate transmission of its RTS frame starting at the selected timeslot because the channel is sensed busy from timeslot #0 onward (because STA₁ 315-a is transmitting RTS₁).

Thereafter, STA₃ 310 receives the RTS frame sent by STA₁ 315-a (denoted as RTS₁), responds with a CTS frame (denoted as CTS₃), and then STA₁ 315-a and STA₃ 310 proceed with communication. In some embodiments, STA₃ 310 is an access point (AP) STA.

Because STA₄ 315-c and STA₅ 315-d sensed the channel as being busy during transmission by STA₁ 315-a of RTS₁, STA₄ 315-c and STA₅ 315-d did not interfere with the second contention round of STA₁ 315-a and STA₂ 315-b due to their setting of the EIFS and NAV, respectively. As noted above, the setting by STA₄ 315-c of the EIFS duration is in response to receiving only a portion of DS₁, whereas the setting by STA₅ 315-d of NAV is in response to STA₅ 315-d receiving DS₂ in its entirety and setting NAV for EIFS based on the duration information in DS₂. As such, these EDCA mechanisms ensure that STAs not involved in a channel access contention round defer their channel access contention until a later contention round, thereby allowing STA₁ 315-a and STA₂ 315-b to proceed with their contention without their own DS or RTS transmissions causing additional interference.

According to some embodiments, if a STA, such as STA₄ 315-c or STA₅ 315-d, does not receive at least the preamble of one of the DS frames sent by STA₁ 315-a and STA₂ 315-b (i.e., DS₁ and DS₂), that STA will not implement any deferment (i.e., NAV or EIFS). Instead, the STA will compete for channel access AIFS[AC] time after sensing the channel as idle.

Under IEEE Std 802.11-2020, when a STA sends a response-soliciting frame (e.g., RTS, ack-soliciting data frame, etc.), the STA needs to wait for ACK Timeout+AIFS[AC] before competing for channel access again in case of the transmission failure. However, during intense, high-priority channel access periods, this waiting time results in unnecessary waste of channel time to detect failed transmissions before competing for channel access again.

Using the HiP EDCA mechanism, a STA sending a DS (Defer Signal) frame (e.g., CTS-to-self) can compete for channel access one AIFS[AC] after the end of the DS frame transmission. The transmission of a DS frame, however, introduces or adds to overhead in terms of channel utilization.

According to some embodiments, therefore, systems, methods, and apparatuses are provided that allow STAs to refrain from waiting for ACK Timeout duration when trying to capture channel resources in order to schedule a TX OP. For example, an STA may determine that it does not need to wait for the ACK Timeout duration before competing again for channel access during especially intense, high-priority EDCA periods.

Also, in some embodiments, the MCS used for the transmission of the DS frame in the HiP EDCA mechanism is typically a low MCS (e.g., non-HT BPSK modulation), which is employed to maintain compatibility with legacy devices and enhance the probability of reception by other STAs for effective contention management. Additionally, a non-HT PHY header is used for the DS frame. Based on these considerations, a minimum duration can be calculated that reflects a minimum amount of time required for a STA using the HiP EDCA mechanism before it can transmit a data frame. The data rate of non-HT BPSK modulation for 1/2 coding rate in a 20 MHz channel is 6 Mbps (see, IEEE Std. 802.11-2020, at Table 10-10). Therefore, the RTS transmission time can be estimated as being approximated 46.67 μs, while the duration of a CTS frame is 38.67 μs, and the DS transmission time is 38.67 μs, assuming that DS is implemented as a CTS-to-self frame.

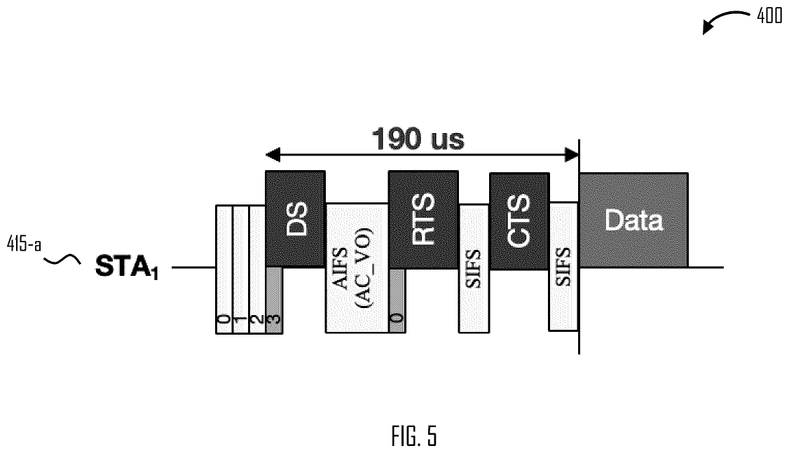

FIG. 5 illustrates an example timing diagram 400 to which one or more examples disclosed herein may be applied. In timing diagram 400, a timeline for EDCA channel access contention procedure retry delay is shown, reflecting the minimum delay incurred by the DS, RTS, and CTS frames before data transmission using the HiP EDCA mechanism. It is assumed that the STA sending the DS frame (STA₁ 415-a) selects the first timeslot (i.e., time slot #0) after the AIFS[AC_VO] period to send its RTS frame. Therefore, the minimum delay incurred between the start of the DS frame and the start of the Data frame can be calculated using a sum of DS, AIFS[AC_VO], RTS, SIFS, CTS, and SIFS; which can be estimated by summing respective values of 38.67 μs+34 μs+46.67 μs+16 μs+38.67 μs+16 μs=190 μs.

Here, AIFS[AC_VO]=SIFS+AIFSN[AC_VO] * SlotTime. Also, the interval between the end of the DS frame and the start of RTS frame is AIFS[AC_VO] because it is assumed that STA₁ 415-a selects timeslot #0 for data transmission following the 190 μs delay. The values used for aSlotTime and SIFS (a.k.a., aSIFSTime) are based on Table 17-21 (OFDMA PHY characteristics for 20 MHz channel spacing) and Table 19-25 (HT PHY characteristics in the 5 GHz band) of IEEE 802.11-2020. However, other values can be used depending on the AC type, STA characteristics or capabilities, implementation differences, and other factors.

The use of a lower MCS, or for instance, using the HT-mixed format PPDU (PHY Protocol Data Unit) or HT-greenfield format PPDU, may result in a higher delay between the start of the DS frame and the Data frame. In addition to the incurred delay, the transmission of DS, RTS and CTS frames further exacerbate channel access contention and wastes channel time that could be used for data transmission during such intense, high-priority contention periods.

To solve these and other problems with the EDCA and HIP EDCA mechanisms under IEEE 802.11 (e.g., IEEE Std. 802.11-2020), provided herein are embodiments using a High-Priority Timeout (HPTO) mechanism. When a STA involved in a EDCA sends a response-soliciting frame (e.g., RTS frame, ack-soliciting data frame), the STA may disable ACK Timeout duration and instead adopt the HPTO mechanism, which provides for a shorter timeout value, before competing for channel access again. The duration of HPTO period allows the STA to compete for channel access after at least HPTOₘᵢₙ=aSIFSTime+aSlotTime following the end of the transmission of its response-soliciting frame, given that the channel has been sensed as idle during HPTOₘᵢₙ. The duration of HPTO may be longer than HPTOₘᵢₙ, in which case the STA must sense the channel as idle during the HPTO duration to be able to compete for channel access after this duration. If the channel is sensed busy during the HPTO, the use of HPTO is cancelled and the STA needs to wait for a frame arrival or an idle channel.

Unlike the HiP EDCA mechanism, HPTO-based EDCA does not rely on the transmission of a Defer Signal. Thus, it reduces contention among STAs without incurring additional control overhead. Also, if the amount of data that a STA needs to send is lesser than a threshold (e.g., RTS threshold), the STA does not need to engage in RTS/CTS engage, while still benefiting from HPTO in case of transmission failures.

The STAs that qualify for high-priority channel access rely on various criteria to decide when to switch between the two possible waiting times, i.e., ACK Timeout vs. HPTO. For example, based on the number of STAs that compete concurrently, the AP may announce a parameter p, which indicates the probability of switching from ACK Timeout to HPTO for each retry effort after experiencing a certain number of failures. The AP and non-AP STA may leverage this method to enhance the probability of successful channel access.

In some embodiments, the HPTO mechanism allows STAs involved in a EDCA period to disable the ACK Timeout duration and instead utilize the shorter HPTO timeout value to determine transmission failure and a next time instance or timeslot at which the STA is eligible for competing again for channel access.

In some embodiments, when a STA sends a response-soliciting frame (e.g., RTS, ack-soliciting data frame), the STA is allowed to compete for channel access again after at least HPTOₘᵢₙ=aSIFSTime+aSlotTime duration after the end of its frame. The HPTO duration may depend on the access class of the STA's traffic, as will be elaborated in the following.

Idle channel detection during HPTOₘᵢₙ is an indication of unsuccessful packet delivery. HPTO's minimum value, HPTOₘᵢₙ, provides a sufficient duration for the STA receiving the response-soliciting frame to receive and process the frame and switch to transmit mode and start transmitting a response frame. The aSlotTime after the aSIFSTime provides the sender of the response-soliciting frame with enough time to perform carrier sensing to determine if there is any signal on the channel, as well as switching its radio to transmit mode. Note that the aSIFSTime+aSlotTime is same as the PIFS (priority inter-frame space) that is used in specific cases that are defined in Section 10.3.2.3.4 of the IEEE 802.11-2020 standard.

In some embodiments, the channel must be sensed as idle during the initial HPTOₘᵢₙ for a STA to be eligible to continue using HPTO in order to compete for channel access again. If the channel is sensed busy at any time during the HPTOₘᵢₙ duration, then the normal EDCA process, which either triggers EIFS or waits for an AIFS[AC] after the idle channel detection, must be followed (Section 10.3.2 of IEEE 802.11-2020 standard).

If the channel is sensed as idle during the HPTOₘᵢₙ duration, the STA will continue to wait out any remaining part of its HPTO (if HPTO is larger than HPTOₘᵢₙ) before competing for channel access. The difference between the STA's HPTO and HPTOₘᵢₙ may depend on parameters such as the STA's traffic access class. The total amount of time since the end of a frame until the next channel access contention round is referred to as HPTO. For example, a STA may use the following:

$$HPTO = {HPTO}_{min +} + ( n - 1 ) * aSlotTime ,$$

where n depends on the AC of the traffic.

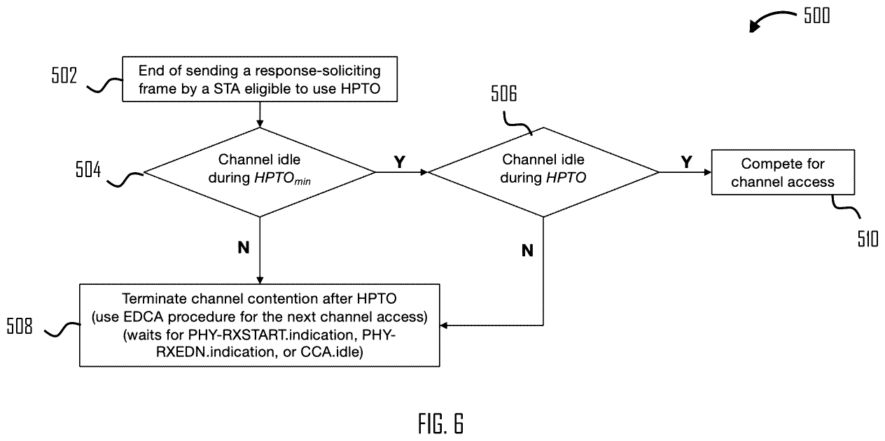

FIG. 6 is a flow diagram illustrating an approach 500 by which an STA can determine whether it is eligible to use HPTO before again competing for channel access by way of an EDCA contention procedure. Some or all elements of the approach 500 can be carried out by one or more computing devices or apparatuses, such as an STA.

In the illustrated approach 500, at block 502, at an end of sending a response-soliciting frame, an STA carrying out the approach 500 can determine whether the STA is eligible to use HPTO. At block 504, if the STA carrying out the approach 500 determines it is eligible to use HPTO, the STA can determine whether the channel was idle during all time slots of the HPTOₘᵢₙ duration. At block 506, if the STA carrying out the approach 500 determines the channel was idle during all time slots of the HPTO duration, the STA can determine whether the channel was idle during all time slots of the HPTO duration. At block 508, if the STA carrying out the approach 500 determines, at block 504, that the channel was busy during at least one time slot of the HPTOₘᵢₙ duration, the STA can terminate channel contention after HPTO and use a EDCA procedure for the next channel access. To do so, in some embodiments, the STA may wait for PHY-RXSTART.inidcation, PHY-RXEND.indication, or CCA.idle. At block 510, however, if, after the STA determines at block 504 that the channel was idle during HPTOₘᵢₙ duration, the STA subsequently determines at block 506 that the channel was idle during the HPTO duration, the retransmit the at least one frame to again compete for channel access.

According to some embodiments, for a particular EDCA contention round (e.g., starting at time t₄), an STA (e.g., STA₄) switches to using HPTO instead of ACK Timeout. After the second failed frame transmissions by STA₁ and STA₄, STA₄ can compete again for channel access starting at to while STA₁ can compete again for channel access starting at t₇. In this scenario, STA₄ uses a HPTO duration, which can be calculated as:

$$HTPO = {HTPO}_{min} + aSlotTime$$

and HTPOₘᵢₙ can be calculated using:

$${HTPO}_{min} + aSIFSTime + aSlotTime$$

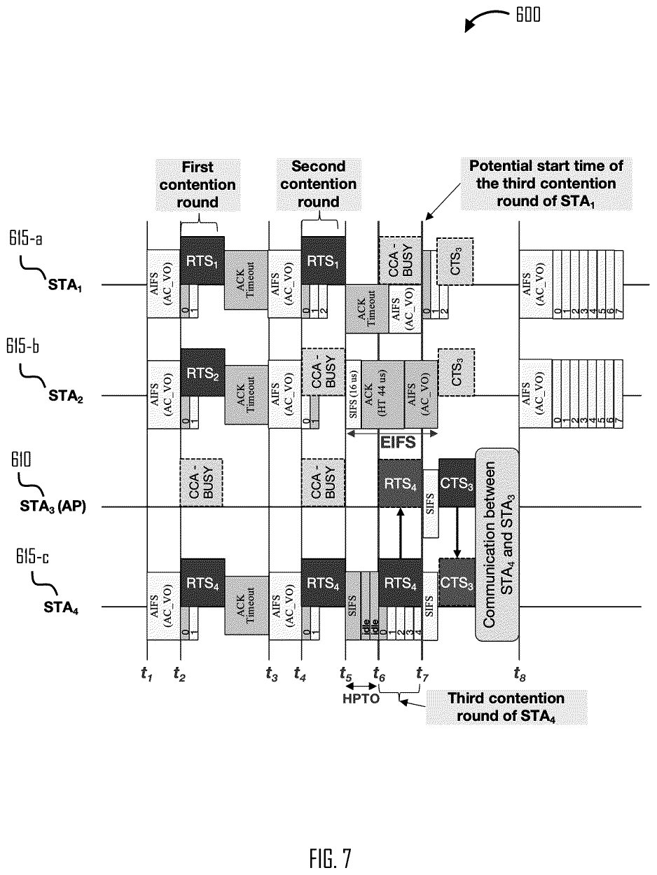

FIG. 7 illustrates an example timing diagram 600 to which one or more examples disclosed herein may be applied. In timing diagram 600, a timeline of EDCA contention resolutions by multiple STAs is illustrated. In the scenario illustrated, a STA switches from using ACK Timeout to HPTO. HPTOₘᵢₙ=aSIFSTime+aSlotTime and HPTO=HPTOₘᵢₙ+aSlotTime. For the scenario illustrated in FIG. 7, it is assumed that the competing non-AP STAs (STA₁ 615-a, STA₂ 615-b, and STA₄ 615-c) have AC_VO traffic to send to STA₃ 610, which is assumed to be an access point (AP). As illustrated, STA₁ 615-a, STA₂ 615-b, and STA₄ 615-c all select timeslot #0 and transmit their RTS frames simultaneously, starting at time t₂. However, due to a collision, none of these frames are successfully received by the destination station (e.g., STA₃ 610).

After sending the RTS frames, STA₁ 615-a, STA₂ 615-b, and STA₄ 615-c initiate the ACK Timeout duration, which is calculated using:

$$ACK Timeout = aSIFSTime + RxPhyStartDelay + aSlotTime ,$$

where RxPhyStartDelay is the delay, in microseconds (μs), from the start of the PPDU at the receiver's antenna to the issuance of the PHY-RXSTART.indication primitive.

The value of RxPhyStartDelay depends on the PHY layer used. In the scenario illustrated in FIG. 7, it is assumed that ACK Timeout is calculated using a aSIFSTime duration of 16 μs, a RxPhyStartDelay duration of 20 μs, and an aSlotTime duration of 9 μs, for a total delay of 45 μs.

Since STA₁ 615-a, STA₂ 615-b, and STA₄ 615-c do not receive any response during this period, these STAs must compete for channel access again after an AIFS[AC_VO] duration following the end of the ACK Timeout duration, starting at to.

The next contention round begins at time t₄. However, during this round, STA₄ 615-c disables ACK Timeout and instead adopts HPTO in case of another failure. In this scenario, it is assumed that the HPTO duration chosen by STA₄ 615-c is HPTOₘᵢₙ+aSlotTime. STA₁ 615-a and STA₄ 615-c both select timeslot #0 and transmit their RTS frames simultaneously at time t₄. Again, none of these frames are successfully received by STA₃ 610. However, STA₂ 615-b detects the PHY header of RTS₁ (sent at t₄) and, as a result, sets the EIFS duration before attempting to access the channel again.

In this scenario, for the calculation of EIFS, it is assumed that the ACK Transmission Time (AckTxTime) used by STA₂ 615-b is around 44 microseconds (for 6 Mbps HT BPSK modulation), based on IEEE 802.11-2020, Table 10-8.

In some embodiments, STA₁ 615-a must wait until time t₈ to contend for the channel again. However, STA₄ 615-c, using HPTO, can attempt channel access earlier. As a result, the third contention round for STA₄ 615-c begins at time to, which is almost five timeslots earlier than that of STA₁ 615-a. In some embodiments, the potential start time of the third contention round of STA₁ 615-a is at t₇. STA₄ 615-c selects timeslot #0 and starts transmitting its RTS frame at time to. This time, the frame is successfully received by the AP (STA₃ 610), which responds with an CTS frame.

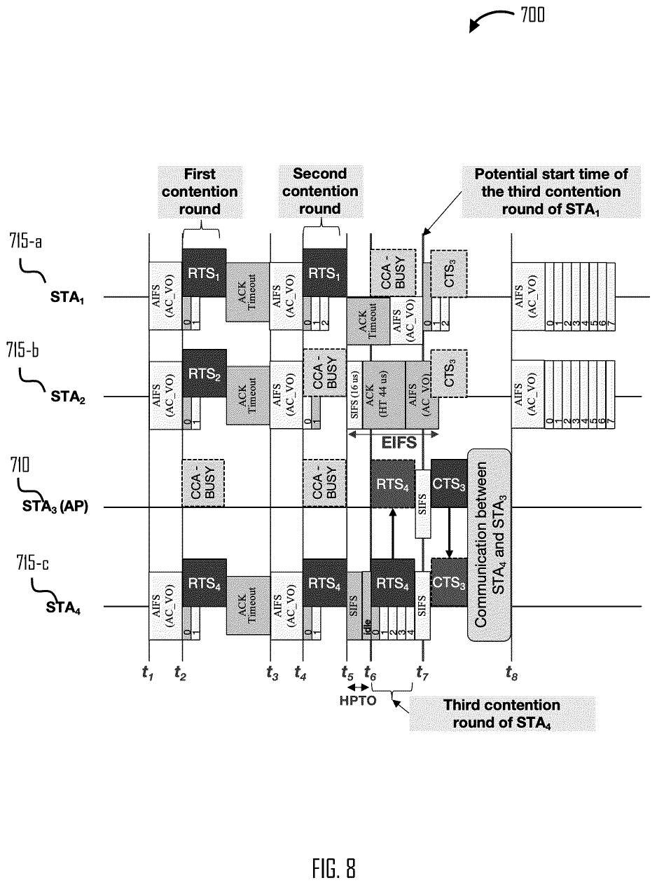

FIG. 8 illustrates an example timing diagram 700 to which one or more examples disclosed herein may be applied. In timing diagram 700, a scenario is illustrated that is similar to that illustrated in the example timing diagram 600 in FIG. 7. However, several differences between these approaches include that STA₄ 715-c uses a HPTO=HPTOₘᵢₙ=aSIFSTime+aSlotTime starting its second contention round. Therefore, the third contention round of STA₄ 715-c starts at time to, which is about six timeslots before the third contention round of STA₁ 715-a starting at t₆.

For the contention round starting at time t₄, STA₄ 715-c switches to using HPTO instead of ACK Timeout. After the second failed transmissions of STA₁ 715-c and STA₄ 715-c, STA₄ 715-c can contend for channel access starting at t₇ while STA₁ 715-a can contend for channel access starting at t₈. In the particular embodiment illustrated in FIG. 8, STA₄ 715-c uses HPTO=HPTOₘᵢₙ=aSIFSTime+aSlotTime.

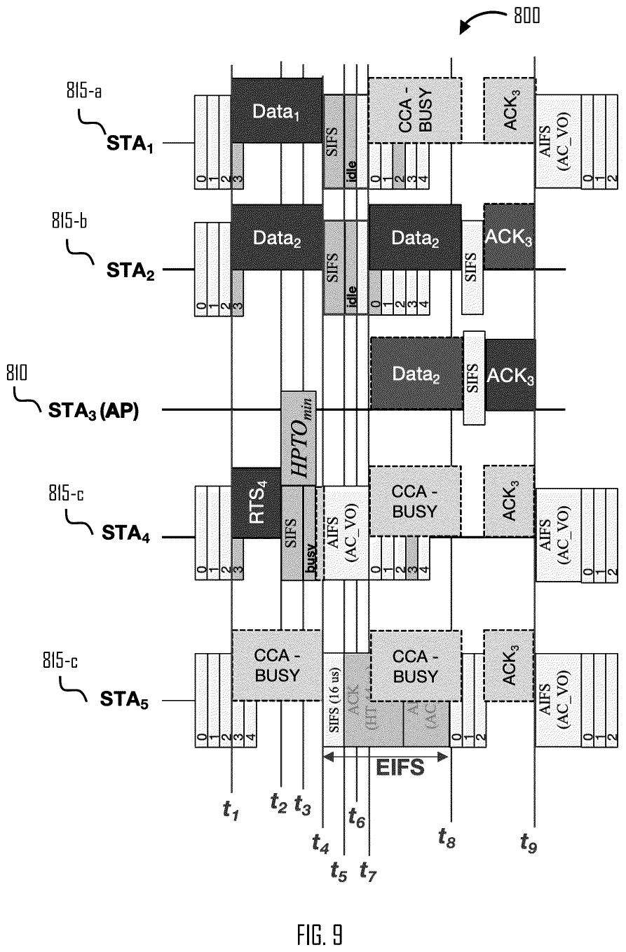

FIG. 9 illustrates an example timing diagram 800 to which one or more examples disclosed herein may be applied. In timing diagram 800, a scenario is illustrated in which competing non-AP STAs (STA₁ 715-c, STA₂ 715-c, STA₄ 715-c and STA₅ 715-c) have AC_VO traffic to send to STA₃ 715-c (AP). It is assumed that all non-AP STAs have already disabled ACK Timeout and are instead using HPTO. Additionally, all non-AP STAs use HPTO=HPTOₘᵢₙ+aSlotTime.

At time t₁, STA₁ 715-c, STA₂ 715-c, and STA₄ 715-c select timeslot #3 and transmit their frames simultaneously. STA₁ 715-c and STA₂ 715-c send data frames, while STA₄ 715-c sends an RTS frame. After the completion of the RTS frame transmission, STA₄ 715-c performs CCA during the timeslot starting at t₃, an aSIFSTime after the RTS frame ends. However, since the channel is sensed as busy due to the ongoing transmission of Data₁ and Data₂ frames, STA₄ 715-c cannot use HPTO to determine its next channel contention round. Instead, according to some embodiments, STA₄ 715-c waits for either a PHY-RXSTART.indication or for the channel to become idle. This waiting period allows STA₄ 715-c the opportunity to receive a potential response to its previously transmitted frame (i.e., RTS₄). However, STA₄ 715-c does not receive any response frame. Notably, STA₄ 715-c does not trigger the EIFS waiting time because the PHY headers of Data₁ and Data₂ frames have already passed. STA₄ 715-c waits until the channel becomes idle and then competes for channel access after AIFS[AC_VO].

When STA₁ 715-c and STA₂ 715-c complete the transmission of their frames at time t₄, they perform CCA during the timeslot after an aSIFSTime. For both STAs, the result of this CCA is an idle channel. However, since HPTO=HPTOₘᵢₙ+SlotTime, STA₁ 715-c and STA₂ 715-c must wait for one more aSlotTime before competing for channel access again. As a result, the first timeslot they can select for the next contention round begins at time t₇.

As observed, the first backoff slot for STA₁ 715-c and STA₂ 715-c aligns with that of STA₄ 715-c. This synchronization occurs because AIFS[AC_VO]=aSIFSTime+2*aSlotTime=HPTOₘᵢₙ+aSlotTime, which is the same waiting period used by STA₄ 715-c after detecting an idle channel. Note that STA₅ 715-c sets the EIFS at time t₄ since it is assumed that STA₅ 715-c received the PHY header of Data₁. Note the second contention round of STA₁ 715-c, STA₂ 715-c, and STA₄ 715-c starts at t₇, whereas the next contention round of STA₅ 715-c starts at t₈.

In the second contention round, which starts at time t₇, STA₂ 715-c selects the first timeslot (timeslot #0) and transmits its Data frame before STA₁ 715-c and STA₄ 715-c. This frame is successfully received by STA₃ 710 (AP), which responds with an ACK frame.

After sending their data frames, STA₁ 715-c and STA₂ 715-c wait for HPTO=HPTOₘᵢₙ+SlotTime before competing for channel access again. With this method, all non-AP STAs start their second round of contention at the same time, regardless of whether they are sending data frame or RTS frame.

A more general formula for the Timeout a STA must wait before contending for channel access after transmitting a response-soliciting frame (e.g., RTS, ack-soliciting data frame) is:

$$B * ( ACK Timeout + AIFS [ AC ] + ( 1 - B ) * ( aSIFSTime + aSlotTime + D * aSlotTime ) ,$$

where, B is a function of one or multiple parameters par₁ through parₙ and determines if ACK Timeout or HPTO is enabled, and D is a function of one or multiple parameters par₁ through parₙ and returns a natural number. Each parameter par; refers to a metric such as the size of the data a STA needs to send, the number of experienced failures, RSSI received from the AP, etc.

For instance, the AP (e.g., STA₃) may allow STAs with data frames less than x bytes to set B=0, disabling their ACK Timeout after experiencing y transmission failures. Also, for these STAs, the AP may announce a function D that depends on multiple parameters such as AC (Access Category) of the traffic, TID (Traffic Identifier) of the traffic, the size of the frame (first frame sent by a STA during a contention round), the number of times that its frames have not been acknowledged, and RSSI from STAs by the AP. For instance, a shorter wait time may be allowed for smaller data frames. Also, a shorter wait time may be allowed for STAs from which the RSSI is less than some predefined threshold.

Various mechanisms can be employed to determine the switching criteria between HPTO and ACK Timeout. If multiple STAs switch to HPTO instead of using ACK Timeout, the duration between channel access contentions will be shorter than when ACK Timeout is used; however, this increased frequency of channel access attempts may reduce the efficiency of collision resolution. Therefore, STAs may adopt locally or globally defined methods or parameters to determine their switching criteria.

As a globally announced or adopted method, the AP may specify two parameters per Access Category (AC): (1) the number of retries needed to make a STA eligible for switching from ACK Timeout to HPTO, and (2) the maximum number of consecutive times a STA can use HPTO for the same frame transmission.

For example, the AP may announce that STAs with AC_VO may switch from ACK Timeout to HPTO after experiencing one failure (when using ACK Timeout), while permitting the use of HPTO for at most two consecutive retries. After completing these two retries, the STA must switch back to ACK Timeout. STAs with AC_VI (video traffic), on the other hand, must wait to switch from ACK Timeout to HPTO until they've experienced two failures when using ACK Timeout, while permitting the use of HPTO for at most one retry. After one retry using HPTO, the STA must switch back to ACK Timeout.

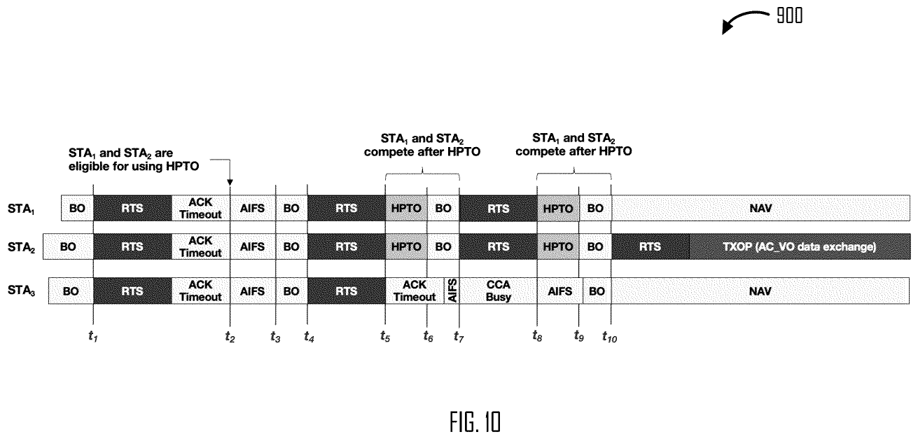

FIG. 10 illustrates an example timing diagram 900 to which one or more examples disclosed herein may be applied. In timing diagram 900, a sample scenario is illustrated in which one or more parameters are enforced. STA₁ 715-c and STA₂ 715-c need to send AC_VO traffic, while STA₃ 715-c needs to send AC_VI traffic. These three STAs send RTS frames simultaneously at time t₁. Since none of them receives a reply, they initiate an ACK Timeout and compete for channel access again at t₃. Also, since STA₁ 715-c and STA₂ 715-c (which have AC_VO traffic) have experienced one failure while using ACK Timeout, they use the HPTO instead of an ACK Timeout to compete for channel access if the next frame transmission fails again. However, since STA₃ 715-c carries AC_VI traffic, it cannot switch to using HPTO yet (because it needs to experience one more failure when using ACK Timeout to become eligible for switching).

The three STAs send RTS frames simultaneously at time t₄, but once again, none receive a reply. Since STA₁ 715-c and STA₂ 715-c use HPTO, they compete for channel access again at t₆ and send RTS frames starting at time t₇. Again, they still do not receive a response to their frames. Since these two STAs are allowed to perform two retries using HPTO, they initiate HPTO timeout again at t₈ and compete for channel access at t₉. According to the illustrated scenario, it is assumed that STA₂ 715-c selects a timeslot positioned before the timeslot selected by STA₁ 715-c. As a result, STA₂ 715-c sends an RTS frame at time t₁₀, which is successfully received by the AP, leading to a TXOP reservation. It is assumed that the correct reception of the RTS from STA₂ 715-c and the CTS reply from the AP allows other STAs to properly set their NAV for the TXOP duration.

Alternatively, as another globally adopted method, the AP may determine the number of competing STAs during high-intensity collision periods and then announce a probability parameter, p, which indicates the likelihood that a STA will be allowed to switch from ACK Timeout to HPTO for each retry. In other words, the probability that B=0 is p. For instance, if the average number of competing STAs is 10, the AP may announce p=0.2, meaning that each STA has a 20% probability of switching to HPTO for each retry.

Alternatively, as another globally adopted method, the AP may announce a time window where HPTO is allowed for eligible STAs. In other words, for HPTO-eligible STAs with B=0, while B reverts to 1 outside of these time windows. Eligible STAs can be identified, for example, explicitly by streams that have LL data to send.

Non-AP STAs may negotiate switching criteria parameters with the AP during Stream Classification Services (SCS) negotiation. This negotiation allows STAs to establish customized parameters for determining when to switch between ACK Timeout and HPTO, optimizing their performance based on network conditions.

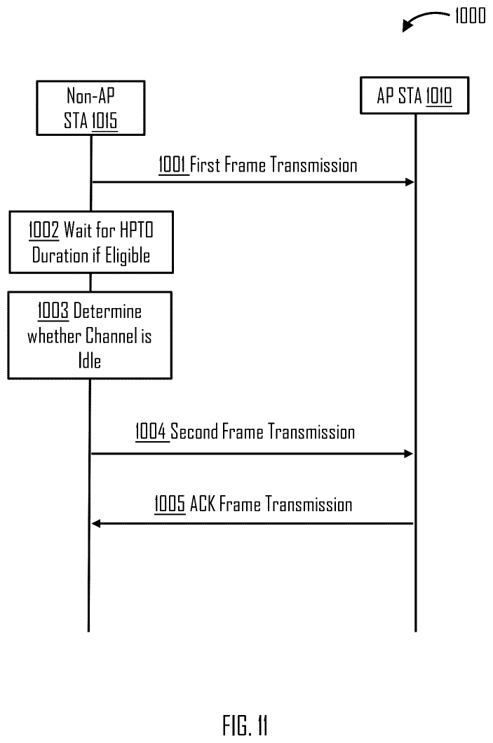

Illustrated in FIG. 11 is an example signaling diagram 1000 to which one or more examples disclosed herein may be applied. In the signaling diagram 1000, communications or signaling is illustrated between a non-AP STA 1015 and an AP STA 1010. Initially, the non-AP STA 1015 can provide or transmit 1001 a first frame transmission towards the AP STA 1010 as part of a first HPTO contention resolution procedure. The non-AP STA 1015 then waits 1002 for an HPTO duration if the non-AP STA 1015 is eligible for HPTO. The non-AP STA 1015 then, after the HPTO duration, determines 1003 whether the channel is idle. If the channel is determined 1003 to be idle during the HPTO duration, the non-AP STA 1015 determines that the second HPTO contention resolution procedure has failed and provides or transmits 1004 a second frame transmission towards the AP STA 1010 as part of a second HPTO contention resolution procedure. If, in response to providing or transmitting 1004 the second frame transmission, the channel remains idle during the HPTO duration, the non-AP STA 1015 can determine that the second HPTO contention resolution procedure has failed. However, if, in response to providing or transmitting 1004 the second frame transmission, the second HPTO contention resolution procedure succeeds, the AP STA 1010 can provide 1005 towards the non-AP STA 1015 an ACK frame transmission.

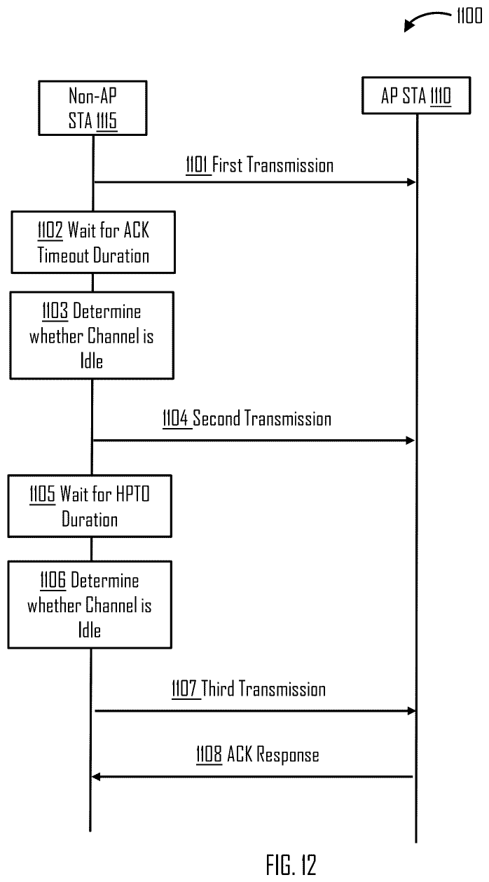

Illustrated in FIG. 12 is an example signaling diagram 1100 to which one or more examples disclosed herein may be applied. In the signaling diagram 1100, communications or signaling is illustrated between a non-AP STA 1115 and an AP STA 1110. Initially, the non-AP STA 1115 can provide or transmit 1101 a first transmission towards the AP STA 1110 as part of a first contention resolution procedure. The non-AP STA 1115 then waits 1102 for an ACK Timeout Duration. The non-AP STA 1115 then, after waiting 1102 for the ACK Timeout Duration, determines 1103 whether the channel is idle. If the channel is determined 1103 to be idle during the ACK Timeout Duration, the non-AP STA 1115 determines that the first contention resolution procedure has failed and provides or transmits 1104 a second transmission towards the AP STA 1110 as part of a second contention resolution procedure.

After providing or transmitting 1104 the second transmission towards the AP STA 1110 as part of the second contention resolution procedure, the non-AP STA 1115 can wait 1105 for an HPTO duration. After waiting 1105 for the HPTO duration, the non-AP STA 1115 can determine 1106 whether the channel has remained idle during the HPTO duration. If the non-AP STA 1115 determines 1106 that the channel has remained idle during the HPTO duration, the non-AP STA 1115 can provide or transmit 1107, during an immediately next timeslot, a third transmission as part of a third contention resolution procedure. If, in response to providing or transmitting 1107 the third transmission, the third contention resolution procedure succeeds, the AP STA 1110 can provide or transmit 1108 towards the non-AP STA 1115 an ACK frame transmission.

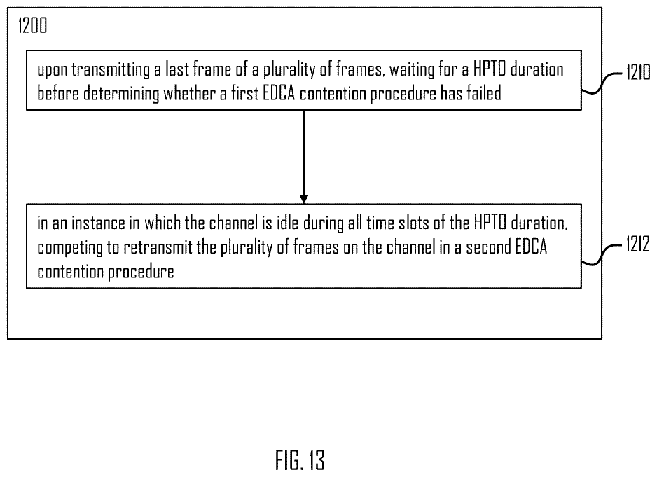

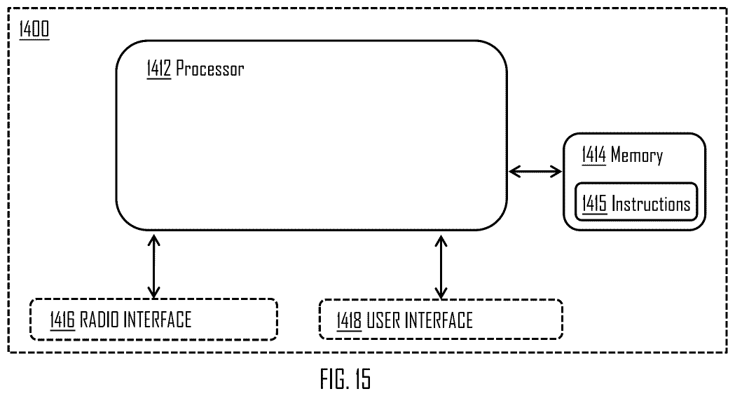

Illustrated in FIG. 13 is an example method 1200 according to one or more examples disclosed herein. In some embodiments, the method 1200 can comprise, upon transmitting a last frame of a plurality of frames, waiting for a HPTO duration before determining whether a first EDCA contention procedure has failed, at 1210. The method 1200 can further comprise, in an instance in which the channel is idle during all time slots of the HPTO duration, competing to retransmit the plurality of frames on the channel in a second EDCA contention procedure, at 1212. The method 1200 is illustrated in FIG. 13 can be a computer-implemented method. The method 1200 may be performed by a device, such as a UE, STA, or an AP illustrated by and described with reference to one or more of the figures. In some examples, the AP may be an example of an apparatus 1400 illustrated by and described with reference to FIG. 15.

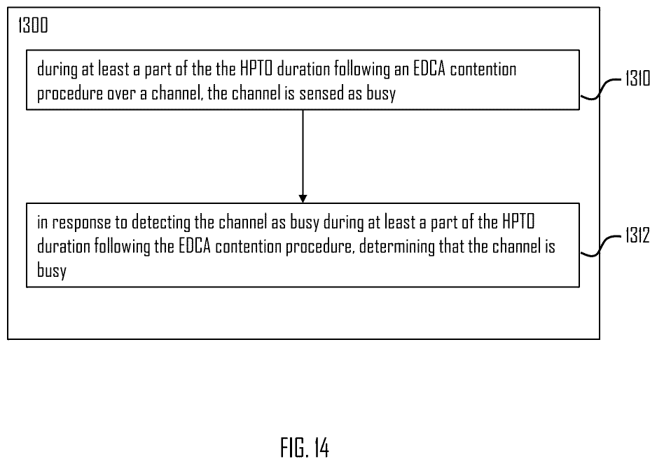

Illustrated in FIG. 14 is an example method 1300 according to one or more examples disclosed herein. The method 1300 can comprise, during an HPTO duration following an EDCA contention procedure over a channel, receiving at least a portion of a frame, at 1310. The method 1300 can further comprise, in response to receiving at least a portion of a frame during the HPTO duration following the EDCA contention procedure, determining that the channel is busy, at 1312. The method 1300 is illustrated in FIG. 14 can be a computer-implemented method. The method 1300 may be performed by a device, such as a UE, STA, or an AP illustrated by and described with reference to one or more of the figures. In some examples, the AP may be an example of an apparatus 1400 illustrated by and described with reference to FIG. 15.

FIG. 15 illustrates an example block diagram of an apparatus 1400 to which one or more examples disclosed herein may be applied. FIG. 15 shows, by way of example, a block diagram of an apparatus 1400. The apparatus 1400 comprises, for example, at least one processor 1402 and at least one memory 1404 storing instructions 1405 thereon or therein that, when executed by the at least one processor 1402, cause the apparatus 1400 at least to perform the method or methods as disclosed herein, and any of the embodiments thereof. In an example, the at least one memory 1404 and the instructions 1405 (e.g., a computer program code, software), are configured, with the at least one processor 1402, to cause the apparatus 1400 to perform the method or methods as disclosed herein, and any of the embodiments thereof.

A processor 1402 may comprise circuitry, or be constituted as circuitry or circuitries, the circuitry or circuitries being configured to perform phases of methods in accordance with one or more example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory (ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 1404 may be implemented using any suitable data storage technology. The memory may comprise a database for storing data. The memory 1404 may be at least in part external to apparatus 1400 but accessible to apparatus 1400.

The instructions 1405 may be comprised in a computer readable medium or a non-transitory computer readable medium. A term non-transitory, as used herein, is a limitation of the medium itself (i.e., tangible, not a signal) as opposed to a limitation on data storage persistency (e.g., random access memory, RAM, vs. read only memory, ROM).

For example, the apparatus 1400 may be a STA, such as an AP STA. As another example, the apparatus 1400 may be comprised in such an STA, e.g., as a chipset configured to control the STA. The apparatus 1400 may be caused or configured to perform at least portions of the processes and/or methods illustrated in FIGS. 11-14 and/or any one or more of the embodiments described.

As another example, the apparatus 1400 may be a non-AP STA. In another example, the apparatus 1400 may be comprised in such a non-AP STA, e.g., as a chipset configured to control the non-AP STA. The apparatus 1400 may be caused or configured to perform at least portions of the processes and/or methods illustrated in FIGS. 11-14 and/or any one or more of the embodiments described.

In some examples, the apparatus 1400 may be a UE, or another type of terminal device.

The apparatus 1400 may comprise one or more entities of any of protocol layers, such as a MAC entity, a radio resource control (RRC) entity, a radio link control (RLC) entity, a packet data convergence protocol (PDCP) entity or a PHY entity. In at least one embodiment, the entity is configured to perform at least portions of the processes and/or methods illustrated in FIGS. 11-14, and/or any one or more of the embodiments described herein.

In some examples, the apparatus 1400 may include a radio interface 1406. The radio interface 1406 may provide the apparatus 1400 with communication capabilities. The radio interface 1406 may comprise a receiver configured to receive information in accordance with at least one cellular or non-cellular standard. The radio interface 1406 may comprise a transmitter configured to transmit information in accordance with at least one cellular or non-cellular standard. The receiver may comprise more than one receiver. The transmitter may comprise more than one transmitter. The radio interface 1406 may comprise a transceiver configured to receive and transmit information in accordance with at least one cellular or non-cellular standard. The transceiver may comprise more than one transceiver.

The apparatus 1400 may comprise a user interface 18 comprising, for example, at least one of a keypad, a microphone, a touch display, a display, a speaker, etc. The user interface 1408 may be used to control the apparatus by the user. The user interface 1408 may be external to the apparatus 1400. For example, the apparatus 1400 may be connected to another device, such as a computer, either via wireless or wired connection, and the apparatus 1400 is controlled by the user via the computer.

In some examples, the apparatus 1400 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. The apparatus 1400 may also include the at least one processor 1402 and/or the at least one memory 1404. The at least one processor 1402 may be used to execute instructions 1405 stored in the at least one memory 1404 and/or to store information in the at least one memory 1404, for example, such as the results of the executed instructions.

In some examples, the at least one processor 1402 of the apparatus 1400 may be in communication with the at least one memory 1404 via a bus for passing information among components of the apparatus 1400. The at least one memory 1404 of the apparatus 1400 may be non-transitory and may include, for example, one or more volatile and/or non-volatile memories. For example, the at least one memory 1404 may be an electronic storage device (e.g., a computer readable storage medium) comprising gates configured to store data (e.g., bits) that may be retrievable by a machine (e.g., a computing device like the processor). The at least one memory 1404 may be configured to store information, data, content, applications, instructions, or the like for enabling the apparatus 1400 to carry out various functions in accordance with an example embodiment of the present disclosure.

In some examples, the apparatus 1400 includes one or more transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver. In some examples, the apparatus 1400 is implemented in or by a user device to which resources on an access interface may be allocated and assigned.

In some examples, the apparatus 1400 is embodied in a chip or chip set. For example, the apparatus 1400 may include one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 1400 may therefore, in some cases, be configured to implement an embodiment of the present disclosure on a single chip or as a single system on a chip (SOC). As such, in some cases, a chip or chipset may constitute means for performing one or more operations for providing the functionalities described herein.

In some examples, the at least one processor 1402 may be embodied in a number of different ways. For example, the at least one processor 1402 may be implemented by processing circuitry. For example, the at least one processor 1402 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC, an FPGA, a microcontroller unit (MCU), a hardware accelerator, a special-purpose computer chip, and/or the like. As such, in some embodiments, the at least one processor 1402 may include one or more processing cores configured to perform independently. A multi-core processor may enable multiprocessing within a single physical package. Additionally, or alternatively, the at least one processor 1402 may include one or more processors configured in tandem via the bus to enable independent execution of instructions, pipelining and/or multithreading.

In an example embodiment, the at least one processor 1402 may be configured to execute instructions 1405 stored in the at least one memory 1404 or otherwise accessible to the at least one processor 1402. Alternatively, or additionally, the at least one processor 1402 may be configured to execute hard coded functionality. As such, whether configured by hardware or software methods, or by a combination thereof, the at least one processor 1402 may represent an entity (e.g., physically embodied in circuitry) capable of performing operations according to an embodiment of the present disclosure while configured accordingly. Thus, for example, when the at least one processor 1402 is embodied as an ASIC, FPGA, and/or the like, the at least one processor 1402 may be specifically configured hardware for conducting the operations described herein. Alternatively, or additionally, as another example, when the at least one processor 1402 is embodied as an executor of instructions 1405, the instructions 1405 may specifically configure the processor 1402 to perform the algorithms and/or operations described herein when the instructions 1405, such as those stored in or on the memory 1404, are executed. However, in some cases, the at least one processor 1402 may be a processor of a specific device (e.g., an image or video processing system) configured to employ an embodiment of the present disclosure by further configuration of the processor 1402 by instructions for performing the algorithms and/or operations described herein. The at least one processor 1402 may include, among other things, a clock, an arithmetic logic unit (ALU), and/or logic gates configured to support operation of the at least one processor 1402.

The radio interface 1406 (e.g., a communication interface) may be a device and/or circuitry embodied in either hardware or a combination of hardware and software that is configured to receive and/or transmit data, including media content in the form of video or image files, one or more audio tracks, and/or the like. In this regard, the radio interface 1406 may include, for example, an antenna (or multiple antennas) and supporting hardware and/or software for enabling communications with a wireless communication network. Additionally, or alternatively, the radio interface 1406 may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), USB or other mechanisms.

In some examples, the apparatus 1400 may be an access point (AP) or a non-AP station (STA) (e.g., such as a client device) usable in a Wi-Fi network capable of operating in accordance with wireless standards (e.g., IEEE 802.11 standards).

In at least one embodiment, at least some of the processes described herein may be carried out by an apparatus comprising means for carrying out at least some of the described processes. Means for performing methods as disclosed herein may include software and/or hardware components of the apparatus 1400. For example, the at least one processor 1402, the memory 1404, and the computer program code (e.g., instructions 1405) form means for carrying out the method or methods as disclosed herein, and any of the embodiments thereof. The term “means” as used in the description and in the claims may refer to one or more individual elements configured to perform the corresponding recited functionality or functionalities, or it may refer to several elements that perform such functionality or functionalities. Furthermore, several functionalities recited in the claims may be performed by the same individual means or the same combination of means. For example, performing such functionality or functionalities may be caused in an apparatus by a processor that executes instructions stored in a memory of the apparatus (e.g., 1400).

Even though the present disclosure has been described above with reference to an example according to the accompanying drawings, it is clear that the present disclosure is not restricted thereto but can be modified in several ways within the scope of the appended claims. Therefore, all words and expressions should be interpreted broadly, and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

What is claimed is:

1. An apparatus comprising:
at least one processor; and
at least one memory comprising program codes stored thereon that, when executed by the at least one processor, cause the apparatus to perform at least:
determining, based at least upon one or more parameters associated with a plurality of frames transmitted by the apparatus in a channel as part of a first enhanced distributed channel access (EDCA) contention procedure to compete for channel access, whether the apparatus is eligible to retransmit the plurality of frames in the channel as part of a second EDCA contention procedure to compete for channel access after only waiting for a high-priority timeout (HPTO) duration following an end of the transmission of the plurality of frames and determining that the first EDCA contention procedure has failed, wherein the HPTO duration is a sum of a short inter-frame space (SIFS) duration and at least one slot duration;
determining, based on whether the channel is sensed as being idle during each slot of the HPTO duration following the end of the transmission of the plurality of frames as part of the first EDCA contention procedure, that the first EDCA contention procedure failed; and
if the first EDCA contention procedure failed and the apparatus is eligible to compete for channel access to retransmit the plurality of frames on the channel immediately following the HPTO duration, starting in a first slot immediately following the end of the HPTO duration as part of the second EDCA contention procedure.

2. The apparatus of claim 1, wherein the plurality of frames comprise at least one of: a response-soliciting frame, a data frame, a short control frame, a clear-to-send (CTS) frame, or a request-to-send (RTS) frame.

3. The apparatus of claim 1, wherein the apparatus performs or participates in the first EDCA contention procedure to compete for channel access to transmit in the channel the plurality of frames addressed to a destination station.

4. The apparatus of claim 1, wherein the one or more parameters comprise information indicating at least one access category (AC) from among a plurality of ACs, the at least one AC being associated with the plurality of frames.

5. The apparatus of claim 4, wherein the program codes stored on the at least one memory, when executed by the at least one processor, further cause the apparatus to perform:
determining whether the at least one AC associated with the plurality of frames is one of a high-priority ACs among the plurality of ACs; and
in an instance in which the channel is idle during each slot of the HPTO duration and the plurality of frames are associated with at least one of the high-priority ACs, determining that the apparatus is eligible to retransmit the transmission in the channel as part of the second EDCA contention procedure to compete again for channel access starting in the first slot following the end of the HPTO duration.

6. The apparatus of claim 1, wherein the one or more parameters associated with the plurality of frames comprise a size of the plurality of frames.

7. The apparatus of claim 6, wherein the program codes stored on the at least one memory, when executed by the at least one processor, further cause the apparatus to perform:
in an instance in which the channel is idle during each slot of the HPTO duration and the size of the plurality of frames is less than a threshold, determining that the apparatus is eligible to compete for channel access to retransmit the plurality of frames in the channel as part of the second EDCA contention procedure starting in the first slot following the end of the HPTO duration.

8. The apparatus of claim 1, wherein the one or more parameters associated with transmission of the plurality of frames comprise a number of experienced EDCA contention procedure failures associated with transmission of the plurality of frames.

9. The apparatus of claim 8, wherein the program codes stored on the at least one memory, when executed by the at least one processor, further cause the apparatus to perform:
in an instance in which the channel is idle during each slot of the HPTO duration and the number of experienced EDCA contention procedure failures associated with transmission of the plurality of frames is more than a threshold, determining that the apparatus is eligible to compete for channel access to retransmit the plurality of frames in the channel as part of the second EDCA contention procedure starting in the first slot following the end of the HPTO duration.

10. The apparatus of claim 1, wherein the one or more parameters associated with the plurality of frames comprise a received signal strength indication (RSSI) associated with a link used to transmit the plurality of frames.

11. The apparatus of claim 10, wherein the program codes stored on the at least one memory, when executed by the at least one processor, further cause the apparatus to perform:
in an instance in which the channel is idle during each slot of the HPTO duration and the RSSI associated with the transmission of the plurality of frames is less than a threshold, determining that the apparatus is eligible to compete for channel access to retransmit the plurality of frames in the channel as part of the second EDCA contention procedure starting in the first slot following the end of the HPTO duration.

12. The apparatus of claim 11, wherein the program codes stored in the at least one memory, when executed by the at least one processor, further cause the apparatus to perform:
in an instance in which the channel is idle during each slot of the HPTO duration and the RSSI associated with the transmission of the plurality of frames is greater than or equal to the threshold, determining that the apparatus is eligible to compete for channel access to retransmit the plurality of frames in the channel as part of the second EDCA contention procedure starting in the first slot following the end of the HPTO duration.

13. The apparatus of claim 1, wherein the channel comprises one of: a physical layer channel, a control channel, a medium access control channel, a shared channel, or a data channel.

14. The apparatus of claim 1, wherein the at least one slot duration is at least one aSlotTime duration.

15. The apparatus of claim 14, wherein the at least one aSlotTime duration includes only a single aSlotTime duration.

16. The apparatus of claim 1, wherein the plurality of frames are addressed to a destination station.

17. The apparatus of claim 16, wherein the destination station is or comprises an access point (AP) station, and wherein the apparatus is or comprises a non-AP station.

18. The apparatus of claim 1, wherein the program codes stored on the at least one memory, when executed by the at least one processor, further cause the apparatus to perform:
determining, based at least upon receipt at the apparatus of at least one response frame, a transmission opportunity (TXOP) following the receipt at the apparatus of the at least one response frame.

19. A method comprising:
determining, based at least upon one or more parameters associated with a plurality of frames transmitted by the apparatus in a channel as part of a first enhanced distributed channel access (EDCA) contention procedure to compete for channel access, whether the apparatus is eligible to retransmit the plurality of frames in the channel as part of a second EDCA contention procedure to compete for channel access after only waiting for a high-priority timeout (HPTO) duration following an end of the transmission of the plurality of frames and determining that the first EDCA contention procedure has failed, wherein the HPTO duration is a sum of a short inter-frame space (SIFS) duration and at least one slot duration;
determining, based on whether the channel is sensed as being idle during each slot of the HPTO duration following the end of the transmission of the plurality of frames as part of the first EDCA contention procedure, that the first EDCA contention procedure failed; and
if the first EDCA contention procedure failed and the apparatus is eligible to compete for channel access to retransmit the plurality of frames on the channel immediately following the HPTO duration, starting in a first slot immediately following the end of the HPTO duration as part of the second EDCA contention procedure.

20. A non-transitory computer-readable storage medium comprising program codes stored therein that, when executed by at least one processor of an apparatus, cause the apparatus to perform at least:
determining, based at least upon one or more parameters associated with a plurality of frames transmitted by the apparatus in a channel as part of a first enhanced distributed channel access (EDCA) contention procedure to compete for channel access, whether the apparatus is eligible to retransmit the plurality of frames in the channel as part of a second EDCA contention procedure to compete for channel access after only waiting for a high-priority timeout (HPTO) duration following an end of the transmission of the plurality of frames and determining that the first EDCA contention procedure has failed, wherein the HPTO duration is a sum of a short inter-frame space (SIFS) duration and at least one slot duration;
determining, based on whether the channel is sensed as being idle during each slot of the HPTO duration following the end of the transmission of the plurality of frames as part of the first EDCA contention procedure, that the first EDCA contention procedure failed; and
if the first EDCA contention procedure failed and the apparatus is eligible to compete for channel access to retransmit the plurality of frames on the channel immediately following the HPTO duration, starting in a first slot immediately following the end of the HPTO duration as part of the second EDCA contention procedure.
